(19) United States
(12) Patent Application Publication
(10) Pub. No.: US 2026/0264774 A1
(43) Pub. Date: Sep. 10, 2026

(54) FIFTH WHEEL LOCKING COUPLER

(71) Applicant: Jost International Corp., Grand Haven, MI (US)

(72) Inventors: Brian J. Hart, Holland, MI (US); Jeremiah D. Hawk, Greeneville, TN (US); Addison S. Karnes, Johnson City, TN (US); William R. Knight, JR., Greeneville, TN (US); Israel T. Hildebrandt, Nunica, MI (US)

(21) Appl. No.: 19/331,584

(22) Filed: Sep. 17, 2025

Related U.S. Application Data
(63) Continuation-in-part of application No. 19/075,250, filed on Mar. 10, 2025.

(51) Int. Cl. B62D 53/08

(52) U.S. Cl. CPC B62D 53/085

(57) ABSTRACT

A fifth wheel can include a pivot lock that is moveable to selectively engage a latch plate at distinct contact points corresponding to locked and unlocked modes of the fifth wheel. The pivot lock can be pivotally joined with an actuator element and/or a lever connected to a lock element holding a kingpin of a trailer. The pivot lock can include a first tooth that engages a latch plate first catch to maintain the locked mode holding the kingpin. The latch plate can include a reset catch. The pivot lock can be moved by biasing members, a manual actuator element and/or the lever. When moved, a second tooth of the pivot lock can selectively engage the reset catch to attain the unlocked mode for kingpin removal. The second tooth can be disengaged from the reset catch via movement of the lever to return to the locked mode.

### BACKGROUND OF THE INVENTION

The present invention relates to a tractor-trailer fifth wheel for connecting a tractor to a trailer, and more particularly to locking mechanisms for fifth wheels.

In the commercial trucking industry, semi-trailer systems are used in which a tractor is coupled to a load carrying trailer for transportation of loads over a road. Fifth wheels are a type of towing setup used primarily for heavy-duty semi-trailer systems, distinguished by their hitching mechanism that involves a specific coupling system. Fifth wheel systems use a large, U-shaped coupling mounted on the chassis of a semi-truck that attaches to a specialized hitch, or a kingpin, connected to the trailer. This setup provides greater stability and weight distribution, making fifth wheels ideal for hauling large trailers with a higher center of gravity. Originating in the early 20th century, the fifth wheel design has evolved to enhance towing safety and ease of use, allowing for smoother tractor rides and better maneuverability compared to other hitch types. The fifth wheel design facilitates ease of use for the operator and increases the robustness of the coupling.

In recent years, to further enhance the security and reliability of fifth wheels, secondary locking mechanisms for fifth wheels have been developed. Secondary locking mechanisms in fifth wheels are crucial safety features designed to ensure the secure attachment of the trailer to the towing vehicle. These mechanisms typically operate in conjunction with a primary locking system, which uses a U-shaped coupling to connect the tractor to the hitch mounted on the trailer. The secondary lock is often a manual or automatic device that engages once the primary lock is secured, providing an additional layer of protection against accidental disengagement. Common examples include a locking pin or a sliding bar that locks the fifth wheel in place, preventing any lateral or vertical movement between the trailer and the truck. This redundancy enhances safety by reducing the risk of trailer detachment, especially during rigorous driving conditions or while maneuvering.

Generally, these secondary locking mechanisms operate by having a latch selectively interface with a notch or protrusion disposed within the body of the fifth wheel. The secondary locking mechanisms are generally disposed at the intersection of a handle that a user moves to unlock or lock the fifth wheel and a lever that translates the movement of the handle to a primary locking mechanism or “jaw” that retains the kingpin within the fifth wheel. However, these secondary locking mechanisms can be cumbersome to lock and unlock, and issues with spontaneous unlocking during rough driving conditions persist.

Accordingly, there remains room for improvement in the field of fifth wheels, and in particular for systems and components to facilitate effective locking and unlocking of fifth wheels, while preventing spontaneous unlocking.

### SUMMARY OF THE INVENTION

A fifth wheel is provided including a pivot lock that is moveable to selectively engage a latch plate at distinct contact points corresponding to locked and unlocked modes of the fifth wheel to thereby respectively secure a kingpin of a trailer to the fifth wheel for transit and to release the kingpin of the trailer to disconnect the trailer from the fifth wheel and an associated tractor, semi, truck or other vehicle.

In one embodiment, the fifth wheel can include a top plate defining a throat configured to receive the kingpin, a lock element movable between a closed position where the lock element blocks removal of the kingpin from the throat and an open position permitting removal of the kingpin from the throat and a lever operatively connected with the lock element.

In another embodiment, the pivot lock can include a pivot lock first tooth and a pivot lock second tooth distal from one another and the pivot lock pivot. The pivot lock can be operatively connected with an actuator element and/or the lever connected to a lock element configured to hold the kingpin.

In still another embodiment, the latch plate can be disposed in proximity to the pivot lock. The latch plate can include a first catch, and a reset catch distal from the first catch. The pivot lock first tooth and pivot lock second tooth can be distal from the lever and can protrude toward the latch plate so that during movement of the pivot lock relative to the latch plate, the pivot lock can toggle about the pivot lock axis, with the first tooth and second tooth riding along a path over and/or adjacent, and in some cases engaging, the first catch and/or the reset catch in different modes.

In yet another embodiment, the pivot lock is operable in a locked mode in which the pivot lock first tooth engages the first catch thereby preventing rotation of the lever and thus securing the lock element in the closed position. In the closed position, the lock element blocks removal of the kingpin from the throat.

In even another embodiment, the pivot lock is operable in an unlocked mode in which the pivot lock second tooth engages the reset catch to hold the lever in a position and thus maintain the lock element in the open position. In the open position, the kingpin is removable from the throat to decouple the trailer from the fifth wheel. Another kingpin of another trailer can be installed in the throat to couple the other trailer to the fifth wheel in the open position.

In a further embodiment, the pivot lock can be moved directly or indirectly via one or more biasing members. A first biasing member can be operatively connected with the pivot lock at an actuator pivot. The first biasing member can be configured to urge the pivot lock to move along the latch plate as the first biasing member moves the lever to transition the lock element from the open position to the closed position.

In still a further embodiment, the pivot lock first tooth moves over the first catch and the reset catch of the latch plate as the pivot lock moves along the latch plate from the closed position to the open position.

In yet a further embodiment, the pivot lock first tooth moves over the reset catch and the first catch of the latch plate as the pivot lock moves along the latch plate from the open position to the closed position.

In even a further embodiment, the pivot lock can be moved by an actuator element that is manually moveable. The actuator element can be operatively connected with the pivot lock at the actuator pivot. The manual actuator can be actuated to disengage the first tooth from the first catch to begin progression to the unlocked mode.

In a further embodiment, the first biasing member can be an air cylinder that can be pressurized or not. When pressurized, the first biasing member can toggle or rotate the pivot lock about the pivot lock axis such that when the actuator element is engaged to disengage the first tooth from the first catch, the first tooth can clear the first catch and move along the latch plate along a first path toward the reset catch of the latch plate. This can in turn allow the lever to rotate relative to the lock element about a lever pivot and can enable the lever to move the lock element toward the open position.

In still a further embodiment, the first biasing member can move the pivot lock such that the first tooth and a second tooth pass beyond a reset catch along the first path. The first biasing element can be deactivated in an inactive mode so that it no longer urges the pivot lock along the first path.

In yet a further embodiment, the fifth wheel can include a second biasing member, which can be configured to urge the pivot lock and its teeth along a second path, opposite the first path. The second biasing member can be joined with the lever and/or or the pivot lock. The second biasing member can urge the pivot lock along the second path after the first biasing element is in the inactive mode. In this condition, the second biasing member can urge the pivot lock second tooth to engage the reset catch to hold the lever in a position and thus maintain the lock element in the open position. In the open position, the kingpin can be removed from the throat and the fifth wheel.

In even a further embodiment, the pivot lock can include a first stop and the lever can include a first limiter. The first stop can engage the first limiter when the pivot lock second tooth engages the reset catch such that the pivot lock is impaired from rotating about the pivot lock axis. In this condition, the pivot lock and the lever are held in a static mode relative to one another so the lever cannot rotate or move the lock element.

In another embodiment, the kingpin can be removed from the throat past the lock element, causing a lock jaw in the throat of the fifth wheel to engage the lock element, thereby moving the lever joined with the pivot lock to thereby disengage the second tooth from the reset catch. The lock jaw maintains the pivot lock in this condition, such that the second tooth is cleared of the reset catch after removal of the kingpin and as another kingpin of another trailer enters the throat and lock jaw, thereby moving the lock element and lever again so that the second biasing member can urge the pivot lock and its teeth along the second path.

In still another embodiment, the pivot lock can include a second stop and the lever can include a second limiter aligned with the second stop. A pivot lock biasing member can be joined between the pivot lock and the lever. The pivot lock biasing member can urge the second stop to engage the second limiter to urge the pivot lock into a reset catch clearance mode in which the pivot lock second tooth clears the reset catch thereby allowing the pivot lock second tooth to travel toward the first catch adjacent the latch plate along the second path.

In yet another embodiment, the second biasing member can move the second tooth over the first catch. The outside face of the first catch can be ramped so that the second tooth and first tooth ride over or past the ramped face to pass the first along the second path, such that the first tooth and second tooth are disposed between the first catch and the first biasing member. With the first tooth behind the first catch, the lock element can be maintained in the locked position.

In even another embodiment, the latch plate can include a safety block. The second tooth can engage the safety block when the draw bar load pulling on the lock element causes the lock element to squirt away from the throat, thereby causing the lever to rotate and thus the pivot lock to move, potentially disengaging or moving the pivot lock first tooth away from the first catch, especially if the pivot lock biasing member malfunctions or fails. The second tooth can ride along the block to engage the safety catch, thereby preventing the first tooth pivot lock generally from clearing the first catch so that the first catch continues to obstruct movement of the first tooth toward the reset catch along or adjacent the latch plate.

In still another embodiment, the fifth wheel includes a secondary catch including a secondary catch arm and defining a secondary catch channel. The pivot lock further defines a pivot lock tail including a pivot lock pin. The pivot lock pin is configured to engage the secondary catch. The pivot lock pin is specifically configured to retainably engage the pivot lock pin and prevent rotation of the pivot lock in a direction. The pivot lock pin is further configured to be displaced through the safety catch channel as the pivot lock transitions between the locked mode and the unlocked mode.

In even a further embodiment, the latch plate includes a leaf spring distal from the first catch with the first catch disposed between the leaf spring and the reset catch. The pivot lock second tooth is configured to engage the leaf spring to prevent the lock element from transitioning from the open position.

In yet another embodiment, the fifth wheel includes a latch keeper coupled with the latch plate, the latch keeper comprising a keeper pin disposed distal from the first catch. The latch keeper defines a latch stop surface configured to contact the pivot lock first tooth.

The current embodiments provide a fifth wheel locking coupler that provides for a safe and efficient locking of the kingpin relative to the fifth wheel. The locking coupler also can enable easy and rapid disconnection of the kingpin from the fifth wheel, along with several fail safes to prevent inadvertent disconnection of the kingpin from the fifth wheel.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1A is a bottom view of a fifth wheel of a current embodiment with a lock element in a locked position to secure a first kingpin relative to the fifth wheel.

FIG. 1B is a close-up bottom view of FIG. 1A, depicting the interface between a pivot lock and a latch plate.

FIG. 2A is a bottom view of the fifth wheel with a first biasing member initially disengaging a pivot lock and a first tooth thereof from a first catch of a latch plate via a first biasing member rotating the first tooth for movement along a first path.

FIG. 2B is a close-up bottom view of FIG. 2A, depicting the interface between a pivot lock and a latch plate.

FIG. 3A is a bottom view of the fifth wheel with the first biasing member continuing to hold the first tooth to clear the first latch as the first tooth moves along the first path toward the reset catch under force of the first biasing member.

FIG. 3B is a close-up bottom view of FIG. 3A, depicting the interface between a pivot lock and a latch plate.

FIG. 4A is a bottom view of the fifth wheel with the first biasing member continuing to hold the first tooth to clear the first latch as the first tooth moves along the first path toward the reset catch under force of the first biasing member.

FIG. 4B is a close-up bottom view of FIG. 4A, depicting the interface between a pivot lock and a latch plate.

FIG. 5A is a bottom view of the fifth wheel with the first biasing member continuing to hold the first tooth and pivot lock moving along the first path toward the reset catch under force of the biasing member, and the second tooth engaging a ramp adjacent the reset catch to reset and rotate back.

FIG. 5B is a close-up bottom view of FIG. 5A, depicting the interface between a pivot lock and a latch plate.

FIG. 6A is a bottom view of the fifth wheel with the second tooth engaging the reset catch moving along the first path about to clear the reset catch under force if the first biasing member.

FIG. 6B is a close-up bottom view of FIG. 6A, depicting the interface between a pivot lock and a latch plate.

FIG. 7A is a bottom view of the fifth wheel with the first tooth and pivot lock at the end of the first path with the pivot lock clearing the latch plate and a first stop of the pivot lock engaging a first limiter of the lever to cease rotation of the pivot lock about the pivot lock axis.

FIG. 7B is a close-up bottom view of FIG. 7A, depicting the interface between a pivot lock and a latch plate.

FIG. 8A is a bottom view of the fifth wheel with the lock element contacting a stop block such that the lever ceases rotation and the lock element ceases movement.

FIG. 8B is a zoom-in bottom view of FIG. 8A, depicting the interfaces of a lever with a pivot lock and a lock element.

FIG. 9A is a bottom view of the fifth wheel with the first biasing member in an inactive mode so that the second biasing member urges the pivot lock along a second path opposite the first path, with the second tooth engaging the reset catch and the lock element maintained in an open position, so that a lock jaw can move open and release the first kingpin.

FIG. 9B is a close-up bottom view of FIG. 9A, depicting the interface between a pivot lock and a latch plate.

FIG. 10A is a bottom view of the fifth wheel with the kingpin exiting the throat and engaging the lock jaw against the lever to disengage the second tooth from the reset catch of the latch plate.

FIG. 10B is a close-up bottom view of FIG. 10A, depicting the interface between a pivot lock and a latch plate.

FIG. 11A is a bottom view of the fifth wheel with the second biasing member urging the pivot lock along the second path past and clearing the reset catch, with the pivot lock rotating about the pivot lock axis relative to the lever, and the first kingpin fully exited from the throat.

FIG. 11B is a close-up bottom view of FIG. 11A, depicting the interface between a pivot lock and a latch plate.

FIG. 12A is a bottom view of the fifth wheel with a second kingpin entering the lock jaw past the lock element, thereby moving the lever, where the pivot lock remains rotated with the second stop engaging the second limiter so the pivot lock is readied to clear the reset catch and move along the second path.

FIG. 12B is a close-up bottom view of FIG. 12A, depicting the interface between a pivot lock and a latch plate.

FIG. 13A is a bottom view of the fifth wheel with the second biasing member urging the pivot lock along the second path, opposite the first path, with the lock element moving to the locked position and the second tooth sliding along a ramped surface adjacent the first tooth to clear the first catch.

FIG. 13B is a close-up bottom view of FIG. 13A, depicting the interface between a pivot lock and a latch plate.

FIG. 14A is a bottom view of the fifth wheel with the pivot lock continuing to travel along the second path toward a longitudinal axis of the fifth wheel, rotating about the pivot lock axis under force of the second biasing member.

FIG. 14B is a close-up bottom view of FIG. 14A, depicting the interface between a pivot lock and a latch plate.

FIG. 15A is a bottom view of the fifth wheel with the pivot lock continuing to travel along the second path toward a longitudinal axis of the fifth wheel, rotating about the pivot lock axis with the first tooth running up the ramp of the first catch.

FIG. 15B is a close-up bottom view of FIG. 15A, depicting the interface between a pivot lock and a latch plate.

FIG. 16A is a bottom view of the fifth wheel with the pivot lock ceasing movement under the force of the second biasing member when the lock element contacts an adjustment bolt, with the first tooth adjacent the lock plate and in a recess adjacent the first catch so that the first tooth cannot move along the first path beyond the first catch to allow the kingpin to move from the closed position to the open position.

FIG. 16B is a close-up bottom view of FIG. 16A, depicting the interface between a pivot lock and a latch plate.

FIG. 17A is a bottom view of the fifth wheel with a kingpin causing the lock element to squirt and rotate the lever and thereby engaging the pivot lock into the first catch.

FIG. 17B is a close-up bottom view of FIG. 17A, depicting the interface between a pivot lock and a latch plate.

FIG. 18A is a bottom view of the fifth wheel with a pivot lock biasing member damaged or disengaged from the pivot lock, with the second tooth engaging a safety block of the latch plate so that the first tooth cannot clear the first catch and move along the first path toward the reset catch to thereby unlock the lock element.

FIG. 18B is a close-up bottom view of FIG. 18A, depicting the interface between a pivot lock and a latch plate.

FIG. 19A is a bottom view of a fifth wheel of another current embodiment with a lock element in a locked position to secure a first kingpin relative to the fifth wheel.

FIG. 19B is a close-up bottom view of FIG. 19A, depicting the interface between a pivot lock, a latch plate, and a leaf spring.

FIG. 20A is a bottom view of the fifth wheel with a first biasing member initially rotating a pivot lock and compressing a leaf spring via a first biasing member rotating the first tooth for movement along a first path.

FIG. 20B is a close-up bottom view of FIG. 20A, depicting the interface between a pivot lock, a latch plate, and a leaf spring.

FIG. 21A is a bottom view of the fifth wheel with the first biasing member continuing to hold the first tooth to clear the first latch as the first tooth moves along the first path toward the reset catch under force of the first biasing member.

FIG. 21B is a close-up bottom view of FIG. 21A, depicting the interface between a pivot lock, a latch plate, and a leaf spring.

FIG. 22A is a bottom view of the fifth wheel with the first biasing member continuing to hold the first tooth to clear the first latch as the first tooth moves along the first path toward the reset catch under force of the first biasing member.

FIG. 22B is a close-up bottom view of FIG. 22A, depicting the interface between a pivot lock, a latch plate, and a leaf spring.

FIG. 23A is a bottom view of the fifth wheel with the first biasing member continuing to hold the first tooth and pivot lock moving along the first path toward the reset catch under force of the biasing member, such that the reset catch is disposed between the first tooth and the second tooth.

FIG. 23B is a close-up bottom view of FIG. 23A, depicting the interface between a pivot lock and a latch plate.

FIG. 24A is a bottom view of the fifth wheel with the first biasing member continuing to hold the first tooth and pivot lock moving along the first path toward the reset catch under force of the biasing member, and the second tooth engaging a ramp adjacent the reset catch to reset and rotate back.

FIG. 24B is a close-up bottom view of FIG. 24A, depicting the interface between a pivot lock and a latch plate.

FIG. 25A is a bottom view of the fifth wheel with the second tooth engaging the reset catch moving along the first path about to clear the reset catch under force if the first biasing member.

FIG. 25B is a close-up bottom view of FIG. 25A, depicting the interface between a pivot lock and a latch plate.

FIG. 26A is a bottom view of the fifth wheel with the first tooth and pivot lock at the end of the first path with the pivot lock clearing the latch plate and a first stop of the pivot lock engaging a first limiter of the lever to cease rotation of the pivot lock about the pivot lock axis.

FIG. 26B is a close-up bottom view of the fifth wheel as the second tooth of the pivot lock clears a reset catch.

FIG. 26C is a close-up bottom view of the fifth wheel as the first tooth of the pivot lock clears a keeper pin.

FIG. 26D is a close-up bottom view of FIG. 26A, depicting the interface between a pivot lock and a latch keeper.

FIG. 27A is a bottom view of the fifth wheel with the lock element contacting a stop block and a latch keeper supporting the pivot lock such that the lever ceases rotation and the lock element ceases movement.

FIG. 27B is a zoom-in bottom view of FIG. 27A, depicting the interfaces of a lever with a pivot lock and a lock element.

FIG. 28A is a bottom view of the fifth wheel with the first biasing member in an inactive mode so that the second biasing member urges the pivot lock along a second path opposite the first path, with the second tooth engaging the reset catch and the lock element maintained in an open position, so that a lock jaw can move open and release the first kingpin.

FIG. 28B is a close-up bottom view of FIG. 28A, depicting the interface between a pivot lock and a latch plate.

FIG. 29A is a bottom view of the fifth wheel with the kingpin exiting the throat and engaging the lock jaw against the lever to disengage the second tooth from the reset catch of the latch plate.

FIG. 29B is a close-up bottom view of FIG. 29A, depicting the interface between a pivot lock and a latch plate.

FIG. 30A is a bottom view of the fifth wheel with the second biasing member urging the pivot lock along the second path past and clearing the reset catch, with the pivot lock rotating about the pivot lock axis relative to the lever, and the first kingpin fully exited from the throat.

FIG. 30B is a close-up bottom view of FIG. 30A, depicting the interface between a pivot lock and a latch plate.

FIG. 31A is a bottom view of the fifth wheel with a second kingpin entering the lock jaw past the lock element, thereby moving the lever, where the pivot lock remains rotated with the second stop engaging the second limiter so the pivot lock is readied to clear the reset catch and move along the second path.

FIG. 31B is a close-up bottom view of FIG. 31A, depicting the interface between a pivot lock and a latch plate.

FIG. 32A is a bottom view of the fifth wheel with the second biasing member urging the pivot lock along the second path, opposite the first path, with the lock element moving to the locked position and the pivot lock contacting the reset catch between the first tooth and the second tooth.

FIG. 32B is a close-up bottom view of FIG. 32A, depicting the interface between a pivot lock and a latch plate.

FIG. 33A is a bottom view of the fifth wheel with the second biasing member urging the pivot lock along the second path, opposite the first path, with the lock element moving to the locked position and the second tooth sliding along a ramped surface adjacent the first tooth to clear the first catch.

FIG. 33B is a close-up bottom view of FIG. 33A, depicting the interface between a pivot lock and a latch plate.

FIG. 34A is a bottom view of the fifth wheel with the pivot lock continuing to travel along the second path toward a longitudinal axis of the fifth wheel, rotating about the pivot lock axis under force of the second biasing member.

FIG. 34B is a close-up bottom view of FIG. 34A, depicting the interface between a pivot lock and a latch plate.

FIG. 35A is a bottom view of the fifth wheel with the pivot lock continuing to travel along the second path toward a longitudinal axis of the fifth wheel, rotating about the pivot lock axis with the first tooth running up the ramp of the first catch.

FIG. 35B is a close-up bottom view of FIG. 35A, depicting the interface between a pivot lock and a latch plate.

FIG. 36A is a bottom view of the fifth wheel with the pivot lock continuing to travel along the second path toward a longitudinal axis of the fifth wheel, rotating along the pivot lock axis with the first tooth running up the ramp of the first catch and the second tooth contacting the leaf spring.

FIG. 36B is a close-up bottom view of FIG. 36A, depicting the interface between a pivot lock, a latch plate, and a leaf spring.

FIG. 37A is a bottom view of the fifth wheel with the pivot lock ceasing movement under the force of the second biasing member when the lock element contacts an adjustment bolt, with the first tooth adjacent the lock plate and in a recess adjacent the first catch so that the first tooth cannot move along the first path beyond the first catch to allow the kingpin to move from the closed position to the open position.

FIG. 37B is a close-up bottom view of FIG. 37A, depicting the interface between a pivot lock, a latch plate, and a leaf spring.

FIG. 38A is a bottom view of the fifth wheel with a kingpin causing the lock element to squirt and rotate the lever and thereby cause a secondary catch to capture a pivot lock pin to prevent pivot lock rotation.

FIG. 38B is a close-up bottom view of FIG. 38A, depicting the interface between a pivot lock, a latch plate, and a leaf spring.

FIG. 39A is a bottom view of the fifth wheel with pivot lock biasing members damaged or disengaged from the pivot lock, with the second tooth engaging a safety catch of the latch plate so that the first tooth cannot clear the first catch and move along the first path toward the reset catch to thereby unlock the lock element.

FIG. 39B is a close-up bottom view of FIG. 39A, depicting the interface between a pivot lock and a latch plate.

FIG. 40A is a bottom view of the fifth wheel with a kingpin entering a lock jaw at a high velocity such that the kingpin forces the lever to pivot the pivot lock, which is prevented from rotating into an unlocked condition.

FIG. 40B is a close-up bottom view of FIG. 40B, depicting the interface between a pivot lock and a latch plate.

### DETAILED DESCRIPTION OF THE CURRENT EMBODIMENTS

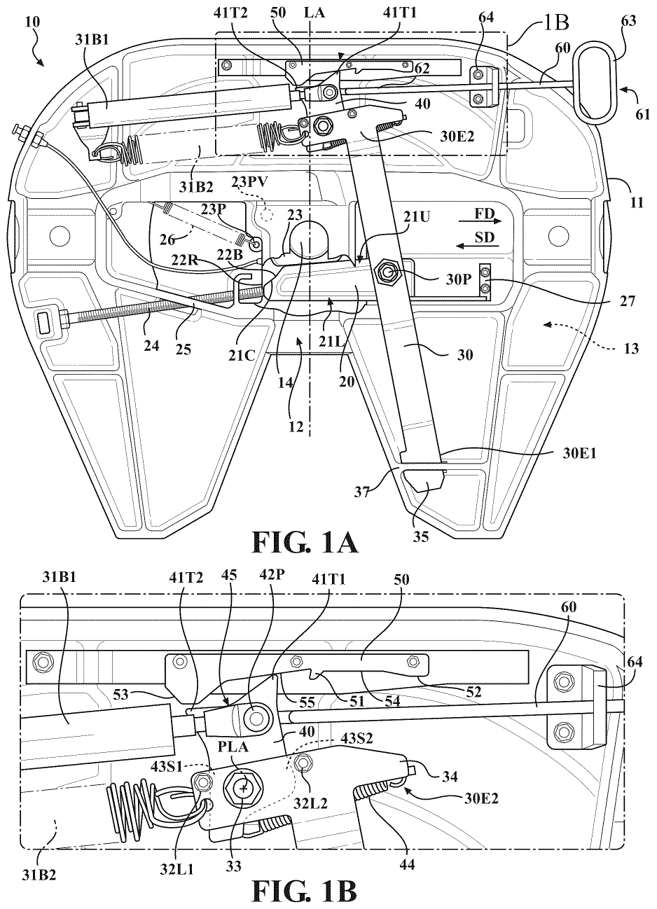

A current embodiment of the fifth wheel is shown in FIGS. 1-18 and generally designated 10. The fifth wheel 10 shown in FIGS. 1-18 is configured for use in a semi-trailer system, wherein the fifth wheel 10 is used to establish a secured connection between a semi-tractor and a semi-trailer. The fifth wheel 10 is mounted on a frame of the semi-tractor (e.g., a rear chassis above a drive axle of the semi-tractor), or another component of a truck, tractor, industrial equipment or vehicle. The fifth wheel 10 can include a top plate 11 defining a throat 12. The top plate 11 can be coupled to a base 13. The base 13 is mountable on the frame of the semi-tractor. The throat 12 is configured to receive a kingpin 14 of a trailer. The top plate 11 can be coupled to the base 13 such that the top plate 11 is pivotable such that the semi-trailer of the semi-trailer system may swivel about the kingpin 14, for example during turning of the semi and trailer or during general articulation between the semi and the trailer. In the semi-trailer system, the top plate 11 can be greased with a lubricant to reduce friction between the top plate 11 and the semi-trailer.

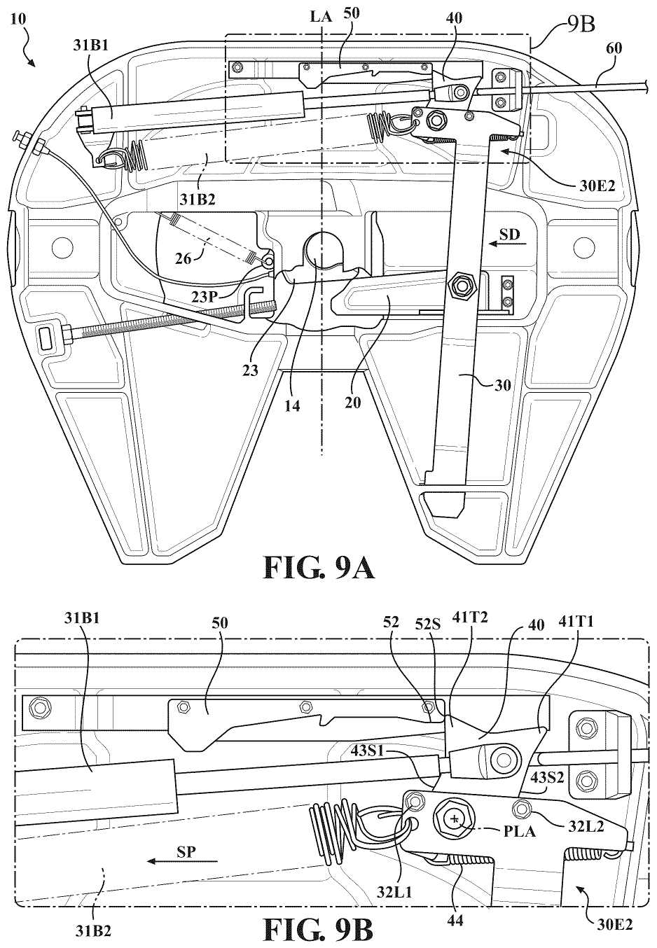

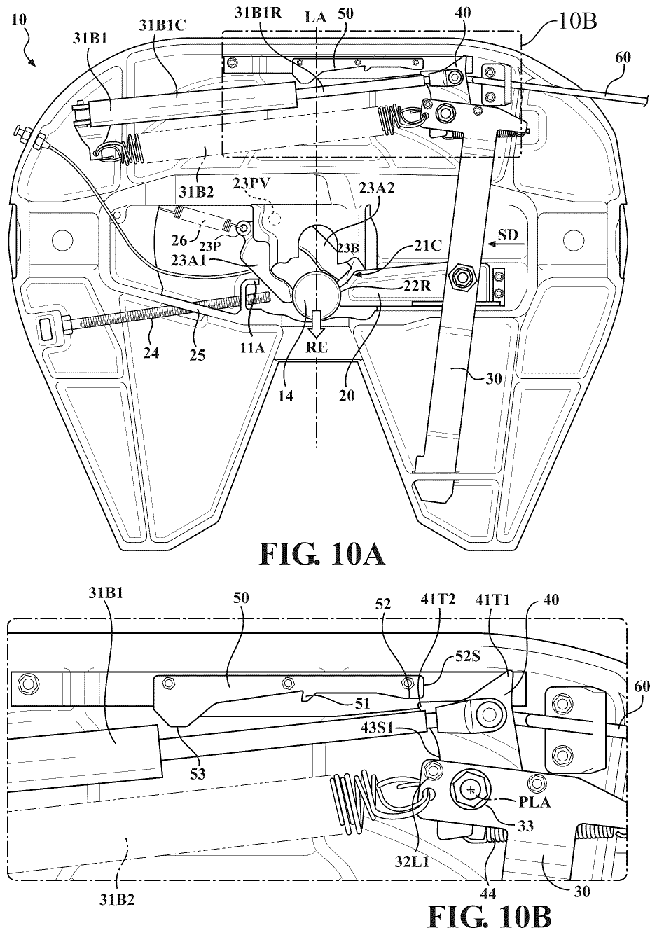

As shown in FIGS. 1-18, the fifth wheel 10 includes a lock element 20 (or a lock bar). The lock element 20 is movable between a closed position shown in FIG. 1A and an open position shown in FIG. 9A. In the closed position the lock element 20 blocks removal of the kingpin 14 from the throat 12. In the open position the removal of the kingpin 14 from the throat 12 is permitted. The lock element 20 can define a forward surface 21U, a rear surface 21L, and a contact surface 21C including a rounded portion 22R and a beveled portion 22B. The forward surface 21U is configured to contact a lock jaw 23. The lock jaw 23 can include a first locking arm 23A1 and a second locking arm 23A2 as shown in FIG. 10A. The lock jaw 23 with the lock element 20 are configured to retainably engage and hold the kingpin 14. The kingpin 14 can be disposed between the first locking arm 23A1 and the second locking arm 23A2 in the locked mode shown in FIG. 1A. The lock element can be in the closed position there to secure the jaw and the king pin in the throat.

The lock jaw 23 can be pivotable about a lock jaw pivot 23PV between the closed position and the open position. In the closed position, shown in FIG. 1A, the forward surface 21U of the lock element 20 can contact the first locking arm 23A1 of the lock jaw 23 such that the lock element 20 and lock jaw 23 block, impair or prevent removal of the kingpin 14 from the throat 12. In the closed position, shown in FIG. 1A, the rounded portion 22R of the contact surface 21C can contact an adjustment bar 24 extending from the top plate 11 through an interior wall 25. The adjustment bar 24 can be screwed in or out relative to the portion 22R to adjust the position of the lock element in the closed position for different parameters. In a knock-off position (e.g., the open position), shown in FIG. 10A, the first locking arm 23A1 contacts a casting rib 11A such that the removal of the kingpin 14 between the first locking arm 23A1 and the rounded portion 22R of the contact surface 21C from the throat 12 is permitted in direction RE. The lock jaw 23 is maintained in the open position from the closed position by a lock jaw biasing member 26. The lock jaw biasing member 26, which can be any type of spring or solenoid, such as a coil spring, leaf spring, etc. can be joined with the lock jaw tether 23P and extends between the lock jaw 23 and the interior wall 25. The kingpin 14 is removable from the throat 12 to decouple the trailer from the fifth wheel 10 when the lock element 20 is in the open position.

The lock element 20 is operatively connected (or rotatably joined) with a lever 30 at a locking bar pivot 30P. The lever 30 can include a first end 30E1 and a second end 30E2. The lock element 20 can be operatively connected with the lever 30 between the first end 30E1 and the second end 30E2 at the locking bar pivot 30P. The fifth wheel 10 can include a first biasing member 31B1 configured to urge the lever 30 in a first direction FD. The fifth wheel 10 can include a second biasing member 31B2 configured to urge the lever 30 in a second direction SD, opposite the first direction FD. The second biasing member 31B2 can be joined with the lever 30 at the second end 30E2. The first biasing member 31B1 can be joined with the pivot lock 40 and can be aligned somewhat with the second biasing member 31B2 such that the biasing members exert opposing forces on the lever urging it in opposite directions in different phases of use of the lever.

The first biasing member and second biasing member can come in different configurations. Optionally, the first biasing member 31B1 can be an air cylinder which can be pressurized and depressurized via an onboard air system. When pressurized, the first biasing member can be put in an active mode in which it can move parts of the system. For example, when pressurized, the first biasing member can extend the ram 31B1R, which can in turn urge or push on the pivot lock 40 in direction FD, generally away from the cylinder 31B1C of the biasing member 31B1. When depressurized, the first biasing member can enter an inactive mode, in which it may not exert force on or urge the lever or other components in a particular direction, along any particular path as described herein. The first biasing member can come in other forms, such as a coil spring, a large solenoid, a hydraulic ram, or other constructions.

Optionally, the second biasing member 31B2 can be a coil spring, or a double coil spring that can be stretched and can store return energy to move the lever when the first biasing member 31B1 is deactivated or placed in an inactive mode. The second biasing member generally can urge or pull on the lever 30 at its second end 30E2 to move the lever in the second direction SD as described further below. The second biasing member can come in other forms, such as an air cylinder, a large solenoid, a hydraulic ram, or other constructions.

The lever 30 optionally can include a first limiter 32L1 and a second limiter 32L2 joined with it somewhere so that those components can interface with the pivot lock to limit its rotation and/or movement during different phases of opening and closing the lock element 20. The first limiter 32L1 and the second limiter 32L2 as shown can be disposed on the second end 30E2 of the lever 30. The lever 30 can include a lever hook 34 and a lever stop 35. The lever hook 34 is disposed on the second end 30E2 of the lever 30, while the lever stop 35 is disposed on the first end 30E1 of the lever 30.

As shown in FIGS. 1A-10B, the fifth wheel 10 can include a pivot lock 40. The pivot lock 40 can be operatively connected (or rotatably joined) with the second end 30E2 of the lever 30 at a pivot lock pivot 33. The pivot lock can rotate about the pivot lock axis PLA counterclockwise and clockwise. The pivot lock 40 can optionally include one or more teeth as defined below designed to interface with corresponding catches of the latch plate 50. For example, the pivot lock 40 can include a pivot lock first tooth 41T1 and a pivot lock second tooth 41T2 distal from the pivot lock pivot 33 and optionally from one another. The first tooth and second tooth can be separated by a concave recess 45 disposed therebetween, with corresponding ramps leading from a low spot in the recess to each of the respective first and second teeth as described below.

As mentioned above, the pivot lock 40 can be joined with and moved via the first biasing member 31B1 and/or a force exerted on the actuator element 60 (or actuator bar). That member can be rotatably and/or pivotally joined with the pivot lock 40 at an actuator pivot 42P such that the pivot lock 40 is moveable, rotatable and/or pivotable about a pivot lock axis PLA as described below. The pivot lock 40 further optionally can include a first stop 43S1 and a second stop 43S2. The first stop 43S1 can be aligned with the first limiter 32L1 of the lever 30 and the second stop 43S2 can be aligned with the second limiter 32L2 of the lever 30. When the first stop and first limiter engage or contact one another during different movements, the pivot lock can cease rotation or other movement. Likewise, when the second stop and the second limiter engage or contact one another, during other movements, the pivot lock can cease rotation or other movement.

Optionally, as shown in FIG. 1B, the pivot lock can be urged and or movement controlled via a pivot lock biasing member 44 which can be joined between the pivot lock 40 and the lever 30. The pivot lock biasing member can be in the form of a coil spring but can be any other type of biasing element described herein. The pivot lock biasing member can generally urge the pivot lock to rotate about the pivot lock axis such that the stop 43S1 engages the limiter 32L1. Optionally, as shown in the figures, the stops of the pivot lock can be in the form of edges of the pivot lock, while the limiters associated with the lever can be in the form of fasteners, pins, projections or other elements. Of course, the construction of the stops and limiters can be reversed and mixed and matched, or come in other forms to limit rotation of the pivot lock in other applications.

As mentioned above, the pivot lock 40 can include a concave recess between different teeth. For example, the pivot lock can define a concave edge 45 between the pivot lock first tooth 41T1 and the pivot lock second tooth 41T2. As used herein, the term “tooth” or “teeth” is understood to mean any protruding structure, ridge, or projection designed to engage, grip, interact with, or apply force to another surface or component. The term includes, but is not limited to, mechanical, structural, or functional protrusions that serve purposes such as locking, guiding, cutting, gripping, or engaging with another element.

With reference to FIGS. 1A-10A, the fifth wheel 10 can include a latch plate 50 disposed in proximity to the pivot lock 40. The latch plate 50 can include a first catch 51 and a reset catch 52 distal from the first catch 51. The latch plate 50 optionally can include a safety catch 53 (e.g., safety block and/or leaf spring). The latch plate 50 can define a ramp 54 disposed between the first catch 51 and the reset catch 52. The latch plate 50 can define a recess 55 disposed between the safety catch 53 and the first catch 51. As used herein, the term “catch” is understood to mean a structural feature designed to engage, retain, restrict, or interface with one or more teeth. The catch may function as a stop, locking mechanism, guide, or engagement point to control movement, positioning, or interaction between components. The term “catch” may include, but is not limited to, recesses, notches, protrusions, latches, or any form of mechanical engagement structure that operates in conjunction with teeth.

The pivot lock 40 and/or the latch plate 50 can be flat or substantially flat. The term “substantially flat” is understood to describe a surface or structure that is primarily planar but may include minor deviations, curvatures, or irregularities that do not significantly affect its intended function. The term allows for slight bends, contours, or non-uniformities. However, the pivot lock 40 and/or the latch plate 50 are not limited to flat or planar configurations, nor to constructions that are plate-like or flat. For example, the pivot lock 40 and/or the latch plate 50 can be curved, contoured, multi-surfaced, or irregularly shaped forms, provided the pivot lock 40 includes one or more teeth 41T2, 41T2 configured to engage with one or more the catches 51, 52, 53 and various ramps, for example, ramp 54 of the latch plate 50. In some cases, the latch plate can be fastened, secured, welded or otherwise secured to the top plate 11. The latch plate optionally can be removable and replaceable relative thereto so that the part can be replaced and/or services after wear and tear or damage thereto. Likewise, the pivot lock can be removable and replaceable relative to the lever and other components in the fifth wheel.

The pivot lock 40 can be moveable and reconfigurable in a variety of modes and can move on different paths depending on the operation of the fifth wheel. For example, the pivot lock can move, rotate and/or toggle from a locked mode to an unlocked mode and vice versa. As shown in FIGS. 1A, 1B, in the locked mode the pivot lock can be positioned so that the pivot lock first tooth 41T1 is aligned to engage the first catch 51. Specifically, the pivot lock 40 is operable in the locked mode such that the pivot lock first tooth 41T1 will engage or is engaged with the first catch 51, thereby preventing rotation of the lever 30 and thus securing the lock element 20 in the closed position shown in FIG. 1A. Optionally, the safety catch 53 of the latch plate 50 is configured to engage the pivot lock second tooth 41T2 when the lock element 20 is in the closed position so that the pivot lock 40 cannot transition from the locked mode to the unlocked mode. For example, the second tooth can engage the safety catch to prevent further rotation of the pivot lock 40 to prevent the first tooth 41T1 from clearing the first catch 51 thereby allowing or facilitating an unlocking condition of the system as described below when a spring fails.

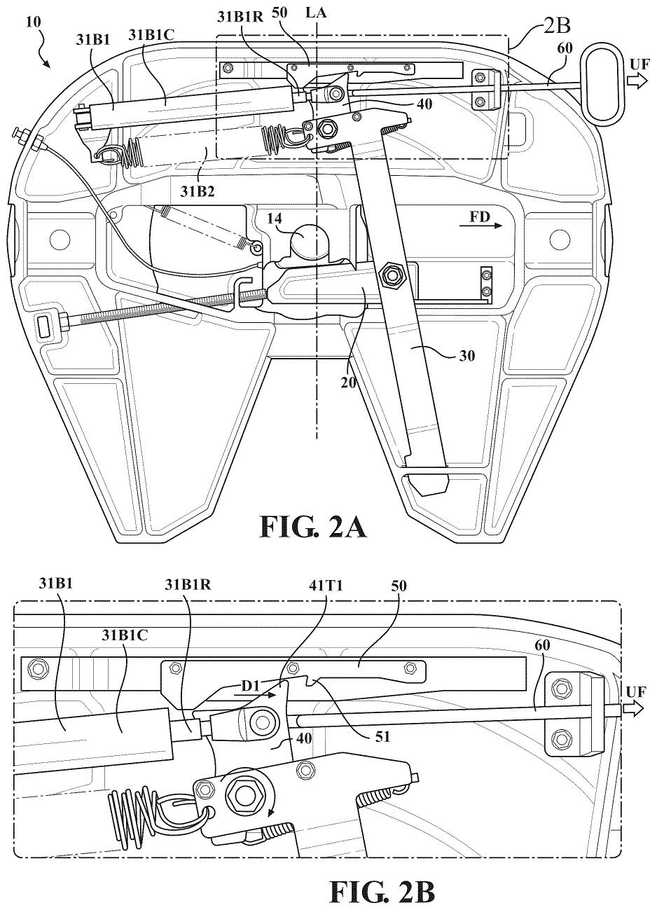

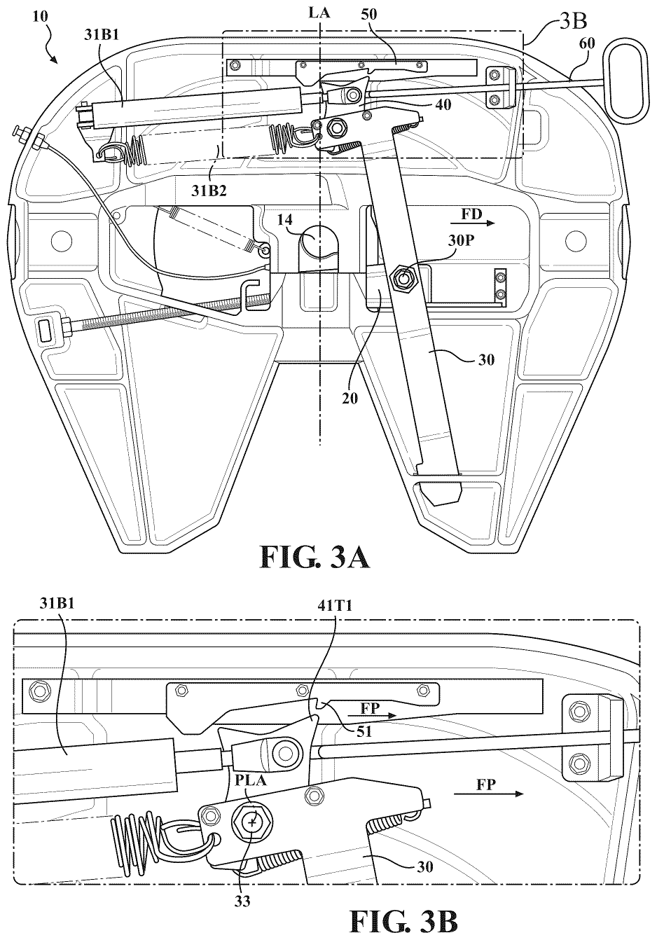

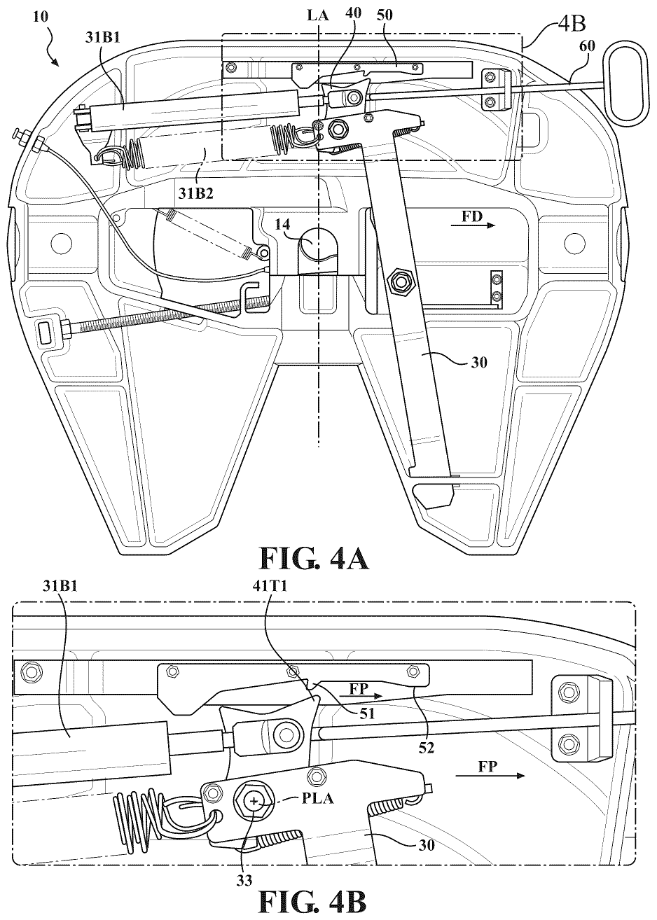

As shown in FIGS. 2A-7B, the first biasing member 31B1 of the lever 30 is configured to urge the pivot lock first tooth 41T1 adjacent the latch plate 50 along a first path FP past the first catch 51 toward and/or past the reset catch 52. The first biasing member 31B1 can be an air cylinder and can be put in an activation mode to extend. As shown in FIG. 2B, the actuator element 60 can be actuated manually by a user via a user force UF, which pulled the pivot lock 40 in direction D1. The second biasing member 31B2 can exert a counterforce and the pivot lock can rotate to initially disengage the pivot lock 40 and the pivot lock first tooth 41T1 from the first catch 51 of the latch plate 50. The first biasing member 31B1 can rotate the pivot lock first tooth 41T1 clockwise, allowing for movement along the first path FP. As shown in FIGS. 3B and 4B, the first biasing member 31B1 continues to hold the pivot lock first tooth 41T1 in a clearance mode such that the pivot lock first tooth 41T1 is able to clear the first catch 51 as the pivot lock first tooth 41T1 moves along the first path FP toward the reset catch 52 under a force of the first biasing member 31B1. As the first biasing member 31B1 moves the pivot lock 40 along the first path FP the lever 30 is likewise rotated clockwise about the locking bar pivot 30P by the force acting on the pivot lock pivot 33 such that the lock element 20 is moved from the closed position toward the open position.

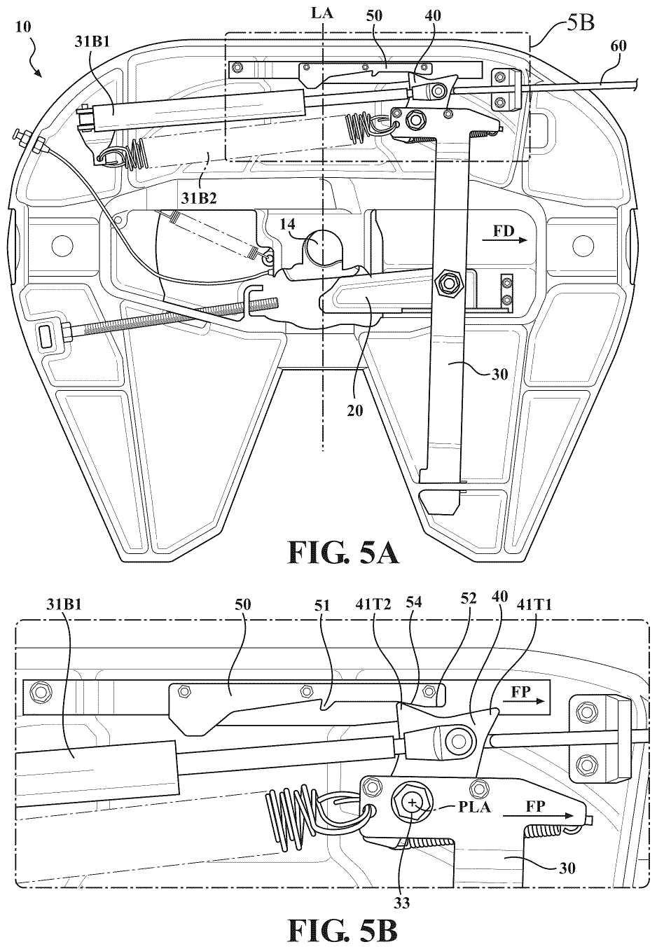

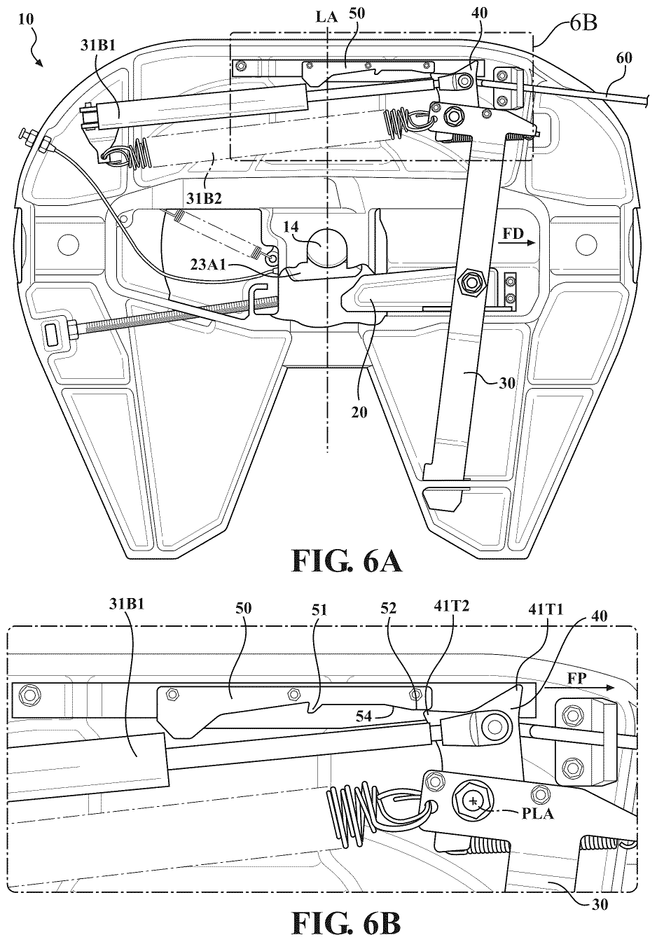

As shown in FIGS. 5A and 5B, the first biasing member 31B1 can continue to move the pivot lock first tooth 41T1 and the pivot lock 40 along the first path FP toward the reset catch 52 under the force of the first biasing member 31B1 and/or a force exerted on the actuator element 60. The pivot lock 40 can pivot clockwise about the pivot lock pivot 33 such that the pivot lock second tooth 41T2 engages the ramp 54. With reference to FIG. 6B, the first biasing member 31B1 continues to move the pivot lock 40 along the first path FP such that pivot lock second tooth 41T2 moves along the ramp 54 until the pivot lock second tooth 41T2 engages the reset catch 52. The pivot lock first tooth 41T1 moves over the reset catch 52 of the latch plate 50 as the pivot lock 40 moves adjacent the latch plate 50. During the movement of the first tooth along the first path, the first tooth optionally moves along or adjacent the latch plate, away from the longitudinal axis LA of the fifth wheel 10. As the tooth moves along the path FP, it further optionally can rotate about the pivot lock axis PLA as described further below.

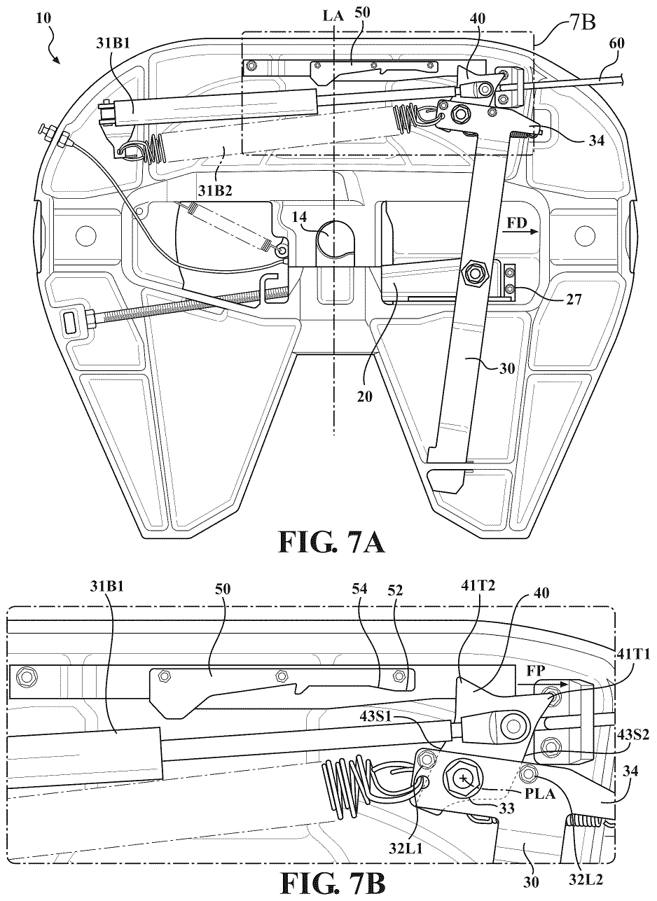

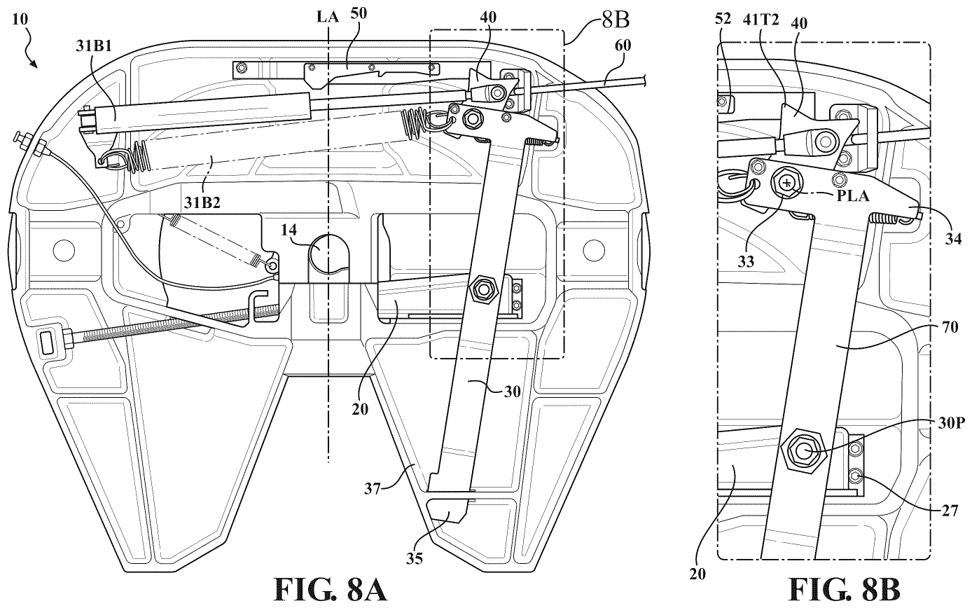

Referring further to FIGS. 6A and 6B, in continuing to convert the lock element from the closed position to the open position to release the king pin, as the first biasing member 31B1 and/or a force exerted on the actuator element 60 moves the pivot lock 40 farther along the first path FP, the pivot lock second tooth 41T2 clears the reset catch 52 of the latch plate 50. Having cleared this rotation-restricting reset catch, as shown in FIGS. 7A and 7B, the pivot lock 40 rotates clockwise. As a result of this rotation, the first tooth moves and rotates away from the longitudinal axis LA until the second stop 43S2 of the pivot lock 40 engages the second limiter 32L2 of the lever 30, ceasing the clockwise rotation of the pivot lock 40 about the pivot lock axis PLA of the pivot lock pivot 33. The pivot lock 40, as well as the tooth 41T1 however, can continue to move along the first path FP until the lock element 20 contacts a stop block 27 and the lever stop 35 contacts a lever stop wall 37 defined by the fifth wheel 10 or top plate 11, thereby stopping the clockwise rotation of the lever 30. The pivot lock 40 at the end of the first path FP is shown in FIG. 8B, where the second tooth 41T2 and pivot lock 40 have well cleared the reset catch 52 of the latch plate 50.

As depicted in FIGS. 9A and 9B, the lever 30 is rotated counterclockwise and the first biasing member 31B1 and/or a force exerted on the actuator element 60 ceases urging the lever 30 along the first path FP, optionally when the first biasing member enters an inactive mode. In this inactive mode, the first biasing member may be operated such that it no longer exerts a force against the lever. This may be achieved if the first biasing member is an air or pneumatic cylinder, and it is no longer pressurized. In the inactive mode of the first biasing member, the second biasing member 31B2 can take over movement forces exerted on the lever, and can urge the lever 30 along a second path SP.

This second path SP optionally can be generally opposite the first path FP, and can be directed back toward the longitudinal axis LA of the fifth wheel. The second end 30E2 of the lever 30 can be pivotally joined with the second biasing member 31B2 configured to urge the pivot lock 40 along the second path SP. The second biasing member 31B2 continues urging the pivot lock second tooth 41T2 to engage the reset catch 52 on its stopping surface 52S to hold the lever 30 in a fixed position, without further rotation under force of the springs 31B2 and maintain the lock element 20 in the open position as shown in FIGS. 9A and 10A. In the knock off position of the lock element shown there, the lock jaw biasing member 26 urges rotation of the lock jaw 23 about the lock jaw pivot 23PV such that the arms 23A1 and 23A2 are open to the throat, so that the kingpin 14 may be released from the throat 12 of the fifth wheel 10.

With reference to FIG. 9B, the pivot lock 40 is operable in the unlocked mode in which the pivot lock second tooth 41T2 engages the reset catch 52 and the surface 52S to hold the lever 30 in a position and maintain the lock element 20 in the open position. The second stop 43S2 engages the second limiter 32L2 of the lever 30 when the pivot lock second tooth 41T2 engages the reset catch 52.

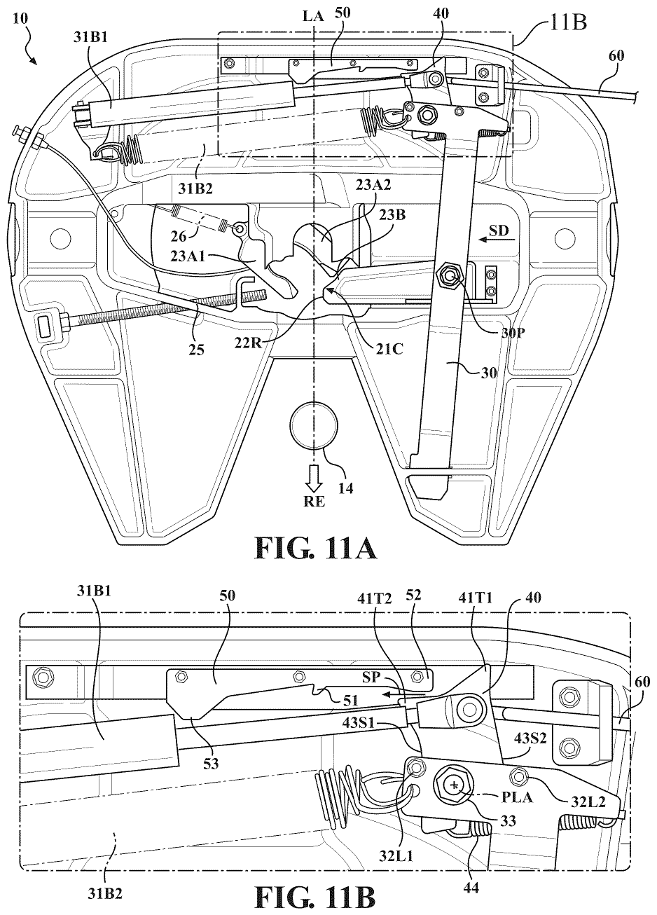

With reference to FIGS. 10A and 11A, the lock jaw 23 pivots about the lock jaw pivot 23PV, transitioning into the open position where the first locking arm 23A1 contacts the casting rib 11A such that the removal of the kingpin 14 between the first locking arm 23A1 and the rounded portion 22R of the contact surface 21C from the throat 12 is permitted. The kingpin 14 contacts the rounded portion 22R of the contact surface 21C of the lock element 20, engaging the lock element 20 against the lever 30 such that the pivot lock second tooth 41T2 is disengaged from the reset catch 52 of the latch plate 50 as shown in FIGS. 10B and 11B. The pivot lock biasing member 44 urges the first stop 43S1 to engage the first limiter 32L1 of the lever 30 to urge the pivot lock 40 into a reset catch clearance mode (e.g., a “ready to couple” condition). In the reset catch clearance mode the pivot lock second tooth 41T2 clears the reset catch 52, allowing the pivot lock second tooth 41T2 to travel toward the first catch 51 along the latch plate 50 along the second path SP with the first tooth.

As depicted in FIGS. 11A and 11B, the second biasing member 31B2 urges the pivot lock 40 along the second path SP such that the pivot lock second tooth 41T2 clears the reset catch 52, with the pivot lock 40 rotating counterclockwise about the pivot lock axis PLA relative to the lever 30. The kingpin 14 can continue in direct RE and can fully exited the throat 12 of the fifth wheel 10.

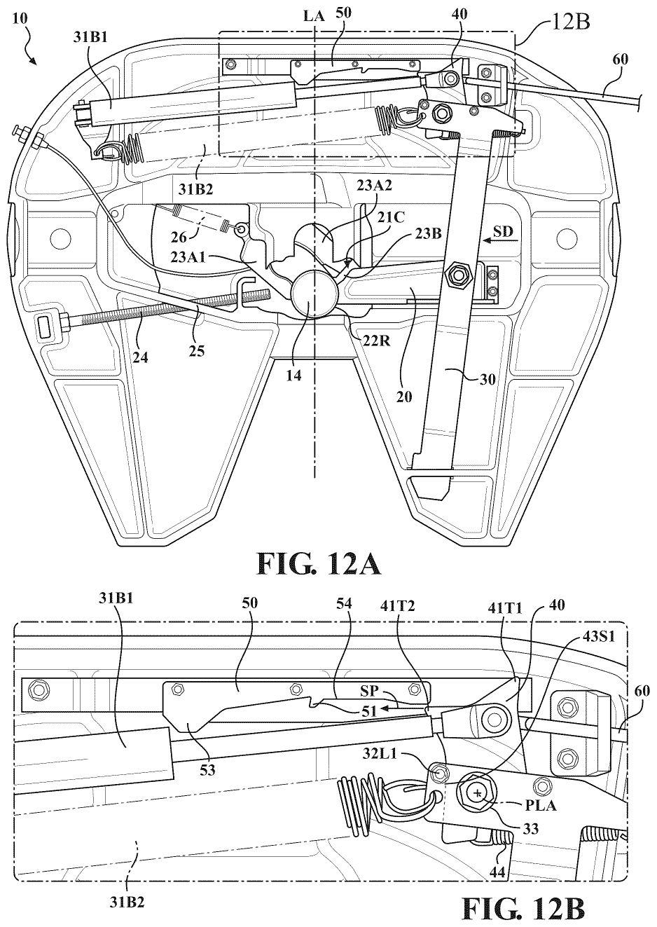

After removal of the kingpin from the fifth wheel, the lock element 20 is held in the open mode by the lock jaw arm 23A2, that kingpin or another kingpin of another trailer can be hooked to the fifth wheel to join a trailer to the vehicle to which the fifth wheel is attached. For example, as shown in FIGS. 12A and 12B, the kingpin 14 (which may be the same or different kingpin as the kingpin that was removed) can enter the lock jaw 23, pass the lock element 20 and contact the rounded portion 22R of the contact surface 21C of the lock element 20. This can engage the lock element 20 against the lever 30. The entry of the kingpin 14 can move the lever 30 such that is rotates clockwise about the locking bar pivot 30P. The pivot lock 40 can rotate such that the first stop 43S1 engages the first limiter 32L1. In this condition, the pivot lock 40 can be configured to move along the second path SP and clear the reset catch.

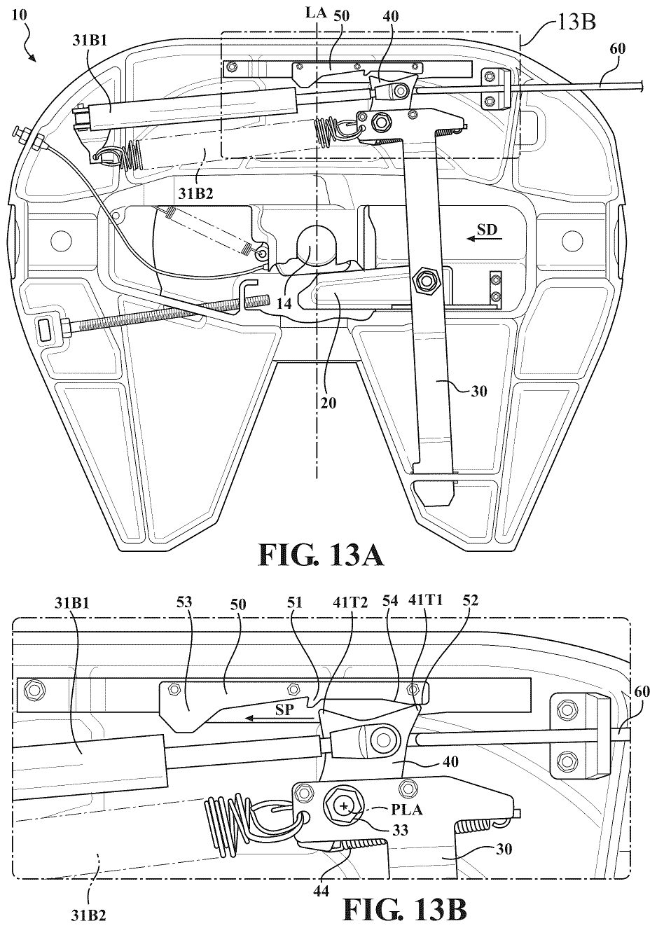

With reference to FIGS. 13A and 13B, the second biasing member 31B2 can urge the pivot lock 40 along the second path SP. The lock element 20 can move from the unlocked position toward the locked position as the pivot lock 40 moves along the second path SP. The pivot lock first tooth 41T1 can engage and slide along the ramp 54 to allow the pivot lock second tooth 41T2 to clear the first catch 51. The pivot lock biasing member 44 can urge the pivot lock 40 to move along the latch plate 50 as the second biasing member 31B2 moves the lever 30 to transition the lock element 20 from the open position to the closed position.

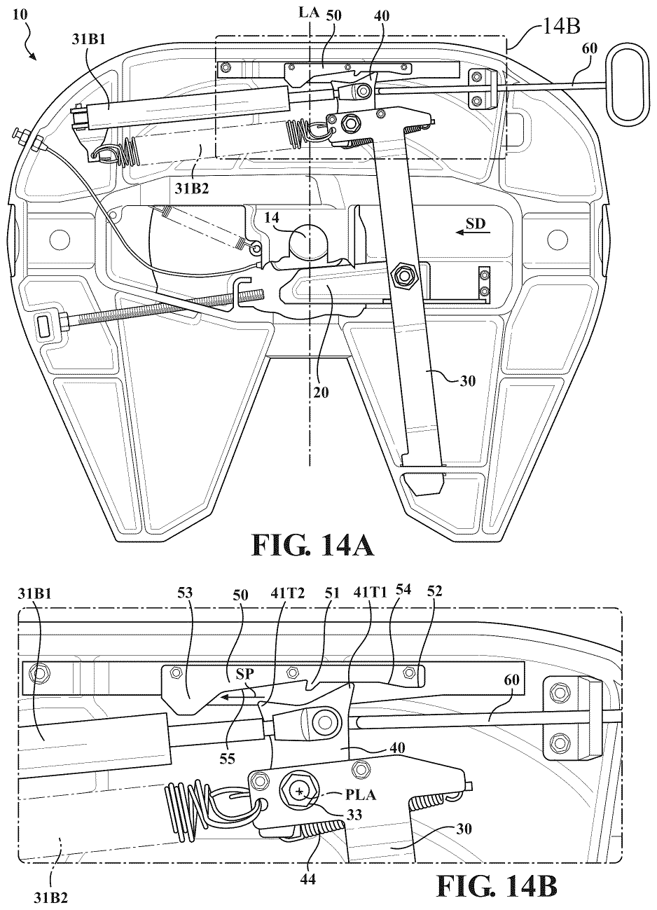

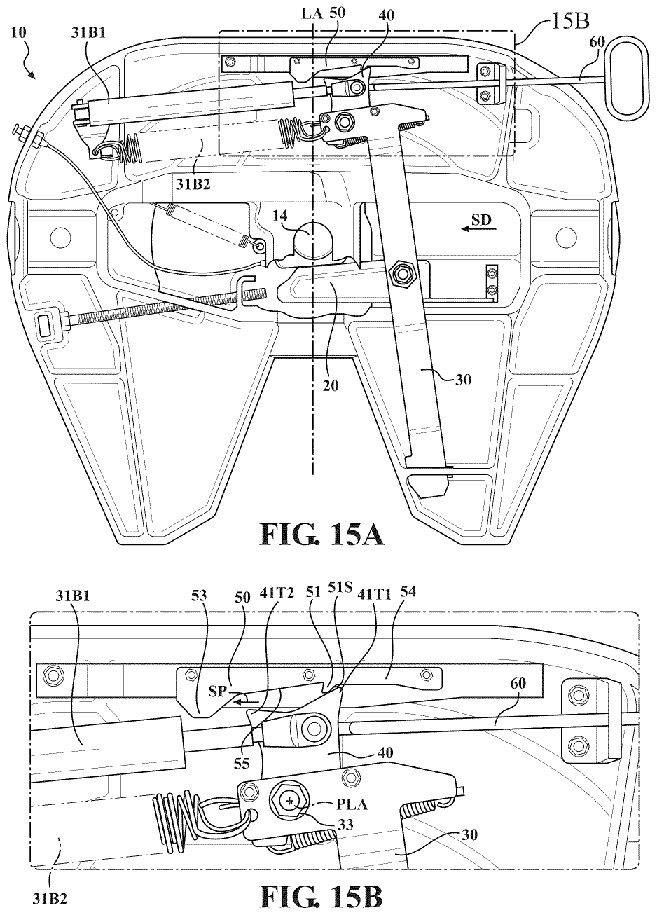

FIGS. 14A and 14B depict the pivot lock 40 continuing to travel along the second path SP toward a longitudinal axis LA of the fifth wheel 10 with the pivot lock second tooth 41T2 clearing the first catch 51. The pivot lock 40 rotates counterclockwise about the pivot lock axis PLA under a force exerted by the second biasing member 31B2. The pivot lock first tooth 41T1 engages and slides along the ramp 54. In FIG. 15B, the pivot lock 40 continues to travel along the second path SP toward a longitudinal axis LA of the fifth wheel 10. The pivot lock 40 rotates counterclockwise about the pivot lock axis PLA such that the pivot lock first tooth 41T1 engages and slides up the ramp 51S on the rear surface of the catch 51 such that the first tooth clears the first catch 51.

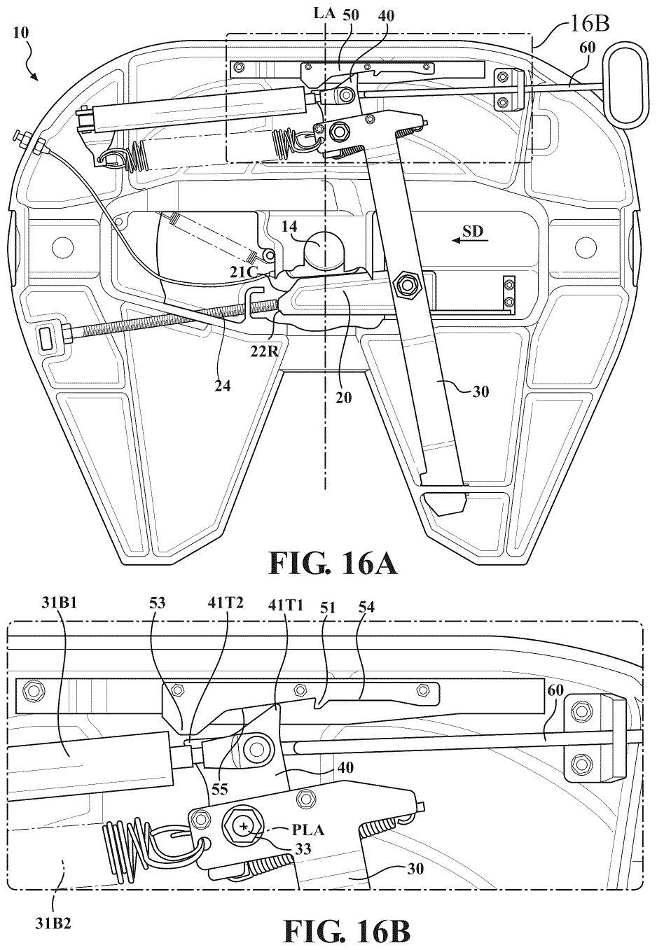

With reference to FIGS. 16A-16B, the pivot lock 40 ceases its movement along the second path SP under the force of the second biasing member 31B2 when the rounded portion 22R of the contact surface 21C of the lock element 20 contacts the adjustment bar 24. The pivot lock first tooth 41T1 is disposed adjacent the latch plate 50 and is located in the recess 55, between the catch 51 and the longitudinal axis LA. The pivot lock first tooth 41T1 is prevented from moving along the first path FP beyond the first catch 51, away from the longitudinal axis. This disposition prevents the movement of the slide bar and/or lock jaw from the closed position to the open position, thereby retaining the kingpin 14.

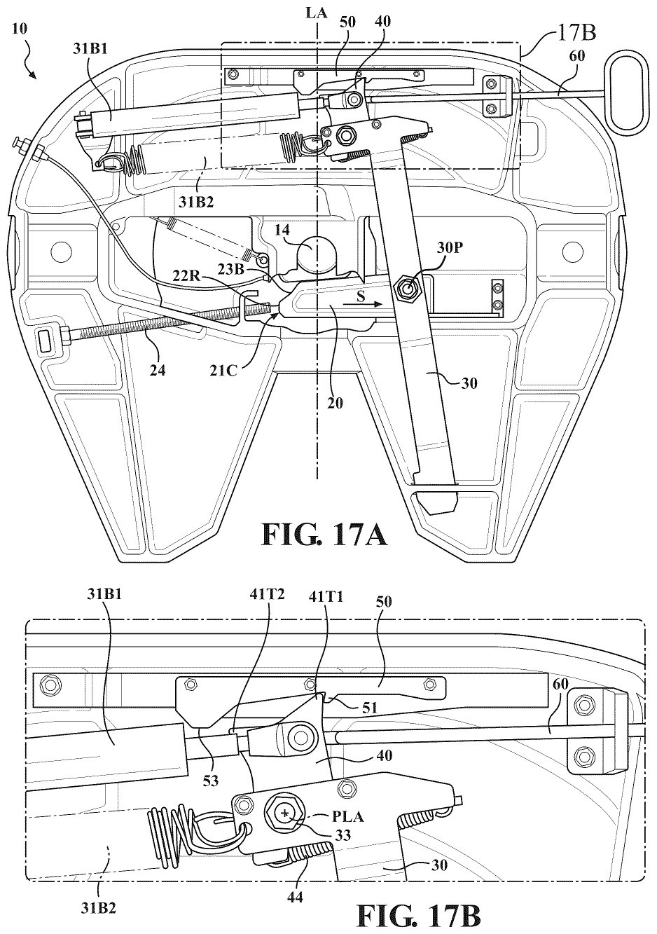

The fifth wheel 10 herein also can provide extra safety features to prevent the pivot lock from inadvertently unlocking during a condition of squirting, for example, when the lock element under tremendous force by the kingpin such that it is urged to move slightly out of the throat, thereby rotating the lever and the associated pivot lock. With reference to FIGS. 17A and 17B, the lock element 20 squirts in direction S such that the rounded portion 22R of the contact surface 21C of the lock element 20 no longer contacts the adjustment bar 24 and rotates the lever 30 clockwise about the locking bar pivot 30P. The pivot lock first tooth 41T1, however, will automatically engage the first catch 51 due to the spring 44, such that the pivot lock 40 cannot move farther along the first path FP beyond the first catch. Accordingly, the lock element cannot move from the closed position to the open position and allow the kingpin 14 to be inadvertently released.

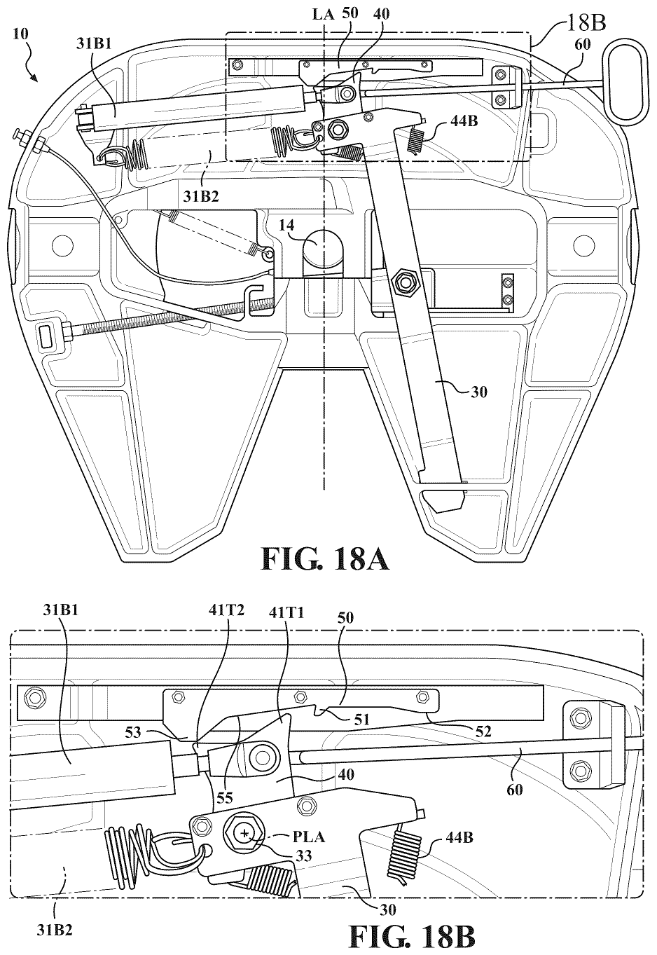

The fifth wheel 10 herein can provide extra safety features to prevent the pivot lock from inadvertently unlocking if a pivot lock biasing member no longer functions to engage the pivot lock first tooth with the first catch, for example, when the pivot lock biasing member is broken into parts (such as a broken coil spring), damaged or disengaged from the pivot lock. For example, FIGS. 18A and 18B show a pivot lock biasing member 44B that has broken into parts, in which case it no longer exerts a force on the pivot lock to engage the catch 51. Even in this broken condition of the spring, however, the pivot lock second tooth 41T2 will engage the safety block 53 of the latch plate 50. This engagement of the pivot lock second tooth 41T2 with the safety block 53 prevents the pivot lock first tooth 41T1 from clearing the first catch 51 and moving along the first path FP toward the reset catch 52. The engagement of the pivot lock second tooth 41T2 and the safety block 53 therefore prevents the lock element 20 from moving from the closed position to the open position. It will be appreciated that the configuration of and engagement between the pivot lock 40 and the latch plate 50 is effective in securely retaining the kingpin 14 within the throat 12 of the fifth wheel 10, even in circumstances where the lock element 20 squirts or the pivot lock biasing member 44 fails.

As mentioned above, the fifth wheel 10 can include an actuator element 60 joined with the pivot lock 40 and configured to move the pivot lock 40. As shown in FIG. 1A, the actuator element 60 can be operatively connected (or rotatably joined) with the pivot lock 40 at the actuator pivot 42P. The actuator element 60 can include a first end 61 and a second end 62. The first end 61 can include a handle 63 disposed outside of the fifth wheel 10 and graspable by a user to move the pivot lock 40. The second end 62 can be operatively connected (or rotatably joined) with the pivot lock 40 at the actuator pivot 42P. The actuator element 60 terminates adjacent the actuator pivot 42P. The actuator element 60 and the first biasing member 31B1 can both be operatively connected (or rotatably joined) with the pivot lock 40 via an actuator pivot 42P extending through the pivot lock 40. The actuator element 60 can be at least partially disposed within an actuator element retainer bracket and guide 64 disposed within the fifth wheel 10.

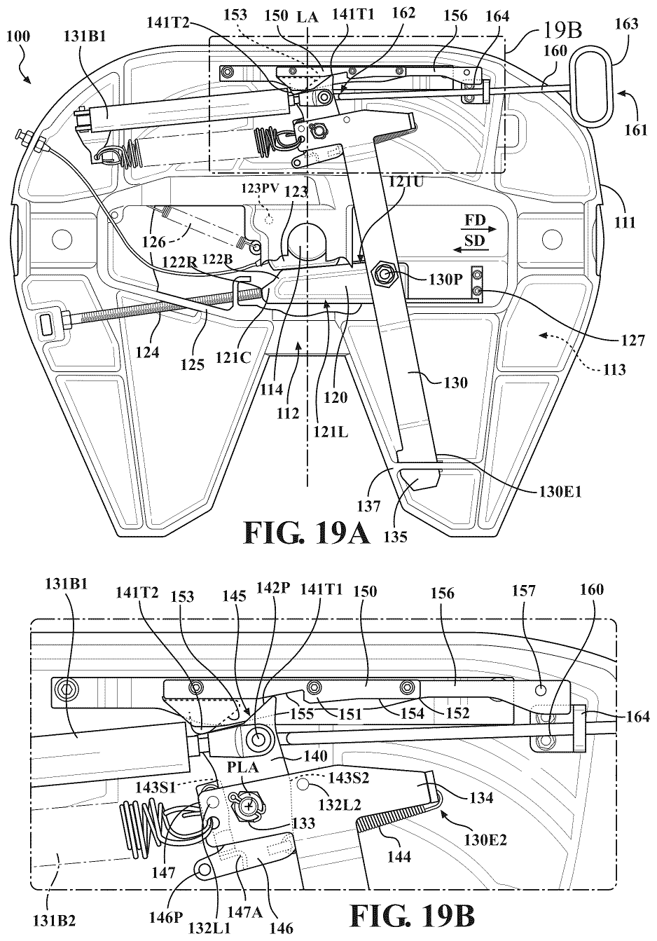

Another current embodiment of the fifth wheel is shown in FIGS. 19-40 and generally designated 100. The fifth wheel 100 shown in FIGS. 19-40 is configured for use in a semi-trailer system, wherein the fifth wheel 100 is used to establish a secured connection between a semi-tractor and a semi-trailer, or any vehicle and a trailer. The fifth wheel 100 is mounted on a frame of the semi-tractor (e.g., a rear chassis above a drive axle of the semi-tractor), or another component of a truck, tractor, industrial equipment or vehicle. The fifth wheel 100 can include a top plate 111 defining a throat 112. The top plate 111 can be coupled to a base 113. The base 113 is mountable on the frame of the semi-tractor. The throat 112 is configured to receive a kingpin 114 of a trailer. The top plate 111 can be coupled to the base 113 such that the top plate 111 is pivotable such that the semi-trailer of the semi-trailer system can swivel about the kingpin 114, for example during turning of the semi and trailer or during general articulation between the semi and the trailer. In the semi-trailer system, the top plate 111 can be greased with a lubricant to reduce friction between the top plate 111 and the semi-trailer.

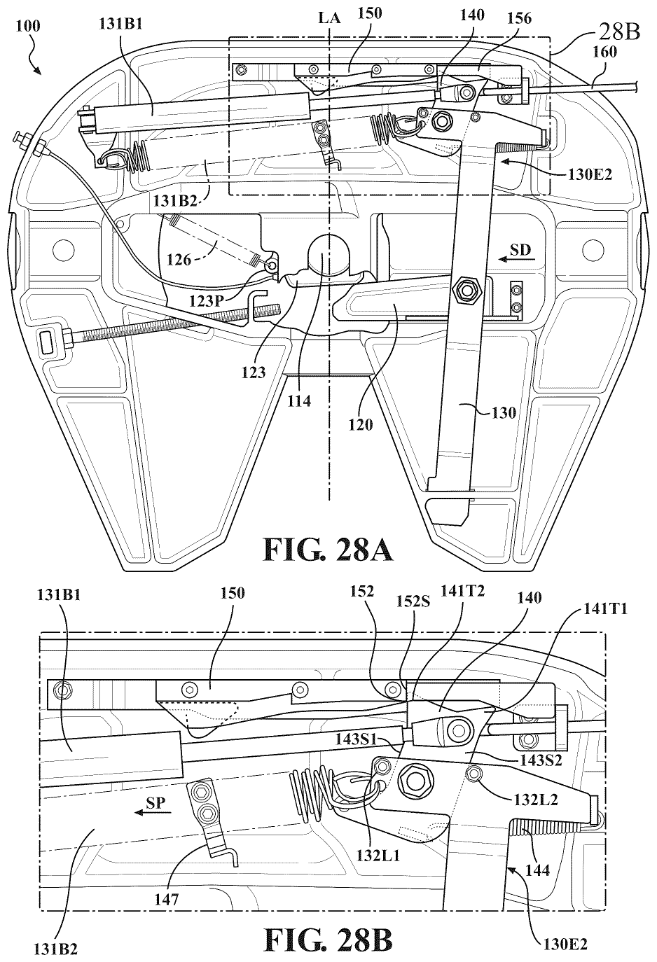

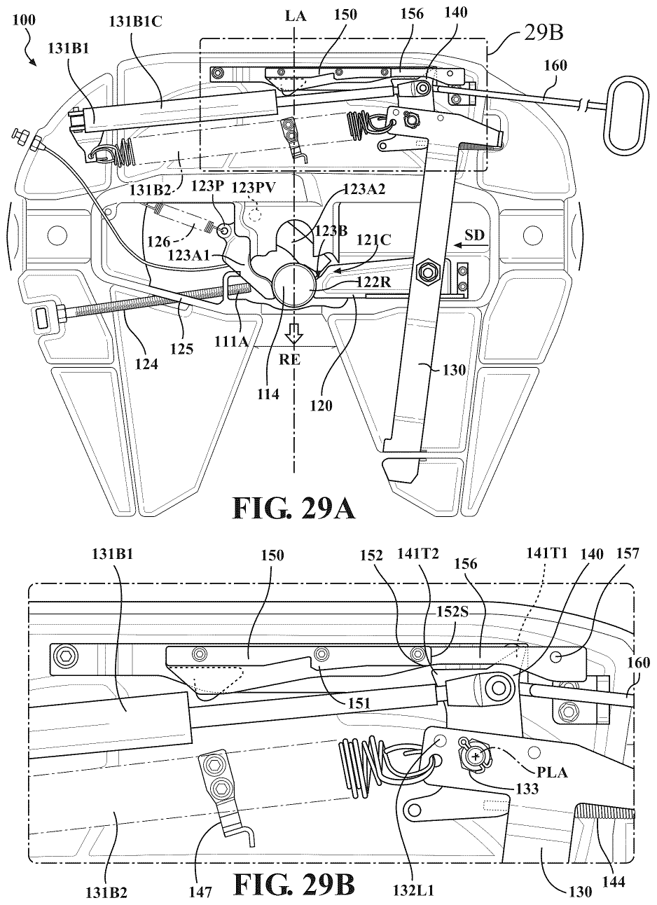

As shown in FIGS. 19-40, the fifth wheel 100 includes a lock element 120 (or lock bar). The lock element 120 is movable between a closed position shown in FIG. 19A and an open position shown in FIG. 28A. In the closed position the lock element 120 blocks removal of the kingpin 114 from the throat 112. In the open position the removal of the kingpin 114 from the throat 112 is permitted. The lock element 120 can define a forward surface 121U, a rear surface 121L, and a contact surface 121C including a rounded portion 122R and a beveled portion 122B. The forward surface 121U is configured to contact a lock jaw 123. The lock jaw 123 can include a first locking arm 123A1 and a second locking arm 123A2 as shown in FIG. 29A. The lock jaw 123 with the lock element 120 are configured to retainably engage and hold the kingpin 114. The kingpin 114 can be disposed between the first locking arm 123A1 and the second locking arm 123A2 in the locked mode shown in FIG. 19A. The lock element 120 can be in the closed position there to secure the jaw 123 and the kingpin 114 in the throat 112.

The lock jaw 123 can be pivotable about a lock jaw pivot 123PV between the closed position and the open position. In the closed position, shown in FIG. 19A, the forward surface 121U of the lock element 120 can contact the first locking arm 123A1 of the lock jaw 123 such that the lock element 120 and lock jaw 123 block, impair or prevent removal of the kingpin 114 from the throat 112. In the closed position, shown in FIG. 19A, the rounded portion 122R of the contact surface 121C can contact an adjustment bar 124 extending from the top plate 111 through an interior wall 125. The adjustment bar 124 can be screwed in or out relative to the portion 122R to adjust the position of the lock element 120 in the closed position for different parameters. In a knock-off position (e.g., the open position), shown in FIG. 29A, the first locking arm 123A1 contacts a casting rib 111A such that the removal of the kingpin 114 between the first locking arm 123A1 and the rounded portion 122R of the contact surface 121C from the throat 112 is permitted in direction RE. The lock jaw 123 is maintained in the open position from the closed position by a lock jaw biasing member 126. The lock jaw biasing member 126, which can be any type of spring or solenoid, such as a coil spring, leaf spring, etc. can be joined with the lock jaw tether 123P and extends between the lock jaw 123 and the interior wall 125. The kingpin 114 is removable from the throat 112 to decouple the trailer from the fifth wheel 100 when the lock element 120 is in the open position.

The lock element 120 is operatively connected (or rotatably joined) with a lever 130 at a locking bar pivot 130P. The lever 130 can include a first end 130E1 and a second end 130E2. The lock element 120 can be rotatably joined with the lever 130 between the first end 130E1 and the second end 130E2 at the locking bar pivot 130P. The fifth wheel 100 can include a first biasing member 131B1 configured to urge the lever 130 in a first direction FD. The fifth wheel 100 can include a second biasing member 131B2 configured to urge the lever 130 in a second direction SD, opposite the first direction FD. The second biasing member 131B2 can be joined with the lever 130 at the second end 130E2. The first biasing member 131B1 can be joined with the pivot lock 140 and can be aligned somewhat with the second biasing member 131B2 such that the biasing members exert opposing forces on the lever 130 urging it in opposite directions in different phases of use of the lever 130.

The first biasing member and second biasing member can come in different configurations. Optionally, the first biasing member 131B1 can be an air cylinder which can be pressurized and depressurized via an onboard air system. When pressurized, the first biasing member can be put in an active mode in which it can move parts of the system. For example, when pressurized, the first biasing member can extend the ram 131B1R, which can in turn urge or push on the pivot lock 140 in direction FD, generally away from the cylinder 131B1C of the biasing member 131B1. When depressurized, the first biasing member can enter an inactive mode, in which it may not exert force on or urge the lever or other components in a particular direction, along any particular path as described herein. The first biasing member can come in other forms, such as a coil spring, a large solenoid, a hydraulic ram, or other constructions.

Optionally, the second biasing member 131B2 can be a coil spring, or a double coil spring that can be stretched and can store return energy to move the lever when the first biasing member 131B1 is deactivated or placed in an inactive mode. The second biasing member generally can urge or pull on the lever 130 at its second end 130E2 to move the lever in the second direction SD as described further below. The second biasing member can come in other forms, such as an air cylinder, a large solenoid, a hydraulic ram, or other constructions.

The lever 130 optionally can include a first limiter 132L1 and a second limiter 132L2 joined with it somewhere so that those components can interface with the pivot lock to limit its rotation and/or movement during different phases of opening and closing the lock element 120. The first limiter 132L1 and the second limiter 132L2 as shown can be disposed on the second end 130E2 of the lever 130. The lever 130 can include a lever hook 134 and a lever stop 135. The lever hook 134 is disposed on the second end 130E2 of the lever 130, while the lever stop 135 is disposed on the first end 130E1 of the lever 130.

As shown in FIGS. 19A-29B, the fifth wheel 100 can include a pivot lock 140. The pivot lock 140 can be rotatably joined with the second end 130E2 of the lever 130 at a pivot lock pivot 133. The pivot lock can rotate about the pivot lock axis PLA counterclockwise and clockwise. The pivot lock 140 can optionally include one or more teeth as defined below designed to interface with corresponding catches of the latch plate 150. For example, the pivot lock 140 can include a pivot lock first tooth 141T1 and a pivot lock second tooth 141T2 distal from the pivot lock pivot 133 and optionally from one another. The first tooth and second tooth can be separated by a concave recess disposed therebetween, with corresponding ramps leading from a low spot in the recess to each of the respective first and second teeth as described below.

As mentioned above, the pivot lock 140 can be joined with and moved via the first biasing member 131B1 and/or a force exerted on the actuator element 160 (or actuator bar). That member can be rotatably and/or pivotally joined with the pivot lock 140 at an actuator pivot 142P such that the pivot lock 140 is moveable, rotatable and/or pivotable about a pivot lock axis PLA as described below. The pivot lock 140 further optionally can include a first stop 143S1 and a second stop 143S2. The first stop 143S1 can be aligned with the first limiter 132L1 of the lever 130 and the second stop 143S2 can be aligned with the second limiter 132L2 of the lever 130. When the first stop and first limiter engage or contact one another during different movements, the pivot lock can cease rotation or other movement. Likewise, when the second stop and the second limiter engage or contact one another, during other movements, the pivot lock can cease rotation or other movement.

Optionally, as shown in FIG. 19B, the pivot lock can be urged and or movement controlled via a pivot lock biasing member 144 which can be joined between the pivot lock 140 and the lever 130. The pivot lock biasing member can be in the form of a coil spring but can be any other type of biasing element described herein. The pivot lock biasing member can generally urge the pivot lock to rotate about the pivot lock axis such that the stop 143S1 engages the limiter 132L1. Optionally, as shown in the figures, the stops of the pivot lock can be in the form of edges of the pivot lock, while the limiters associated with the lever can be in the form of fasteners, pins, projections or other elements. Of course, the construction of the stops and limiters can be reversed and mixed and matched, or come in other forms to limit rotation of the pivot lock in other applications.

As mentioned above, the pivot lock 140 can include a concave recess between different teeth. For example, the pivot lock can define a concave edge 145 between the pivot lock first tooth 141T1 and the pivot lock second tooth 141T2. As used herein, the term “tooth” or “teeth” is understood to mean any protruding structure, ridge, or projection designed to engage, grip, interact with, or apply force to another surface or component. The term includes, but is not limited to, mechanical, structural, or functional protrusions that serve purposes such as locking, guiding, cutting, gripping, or engaging with another element.

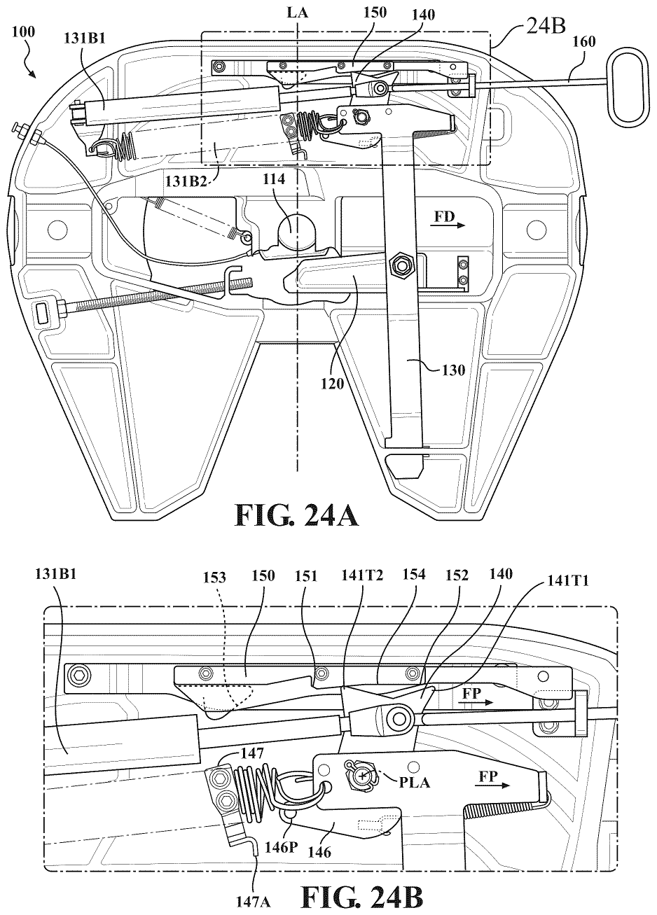

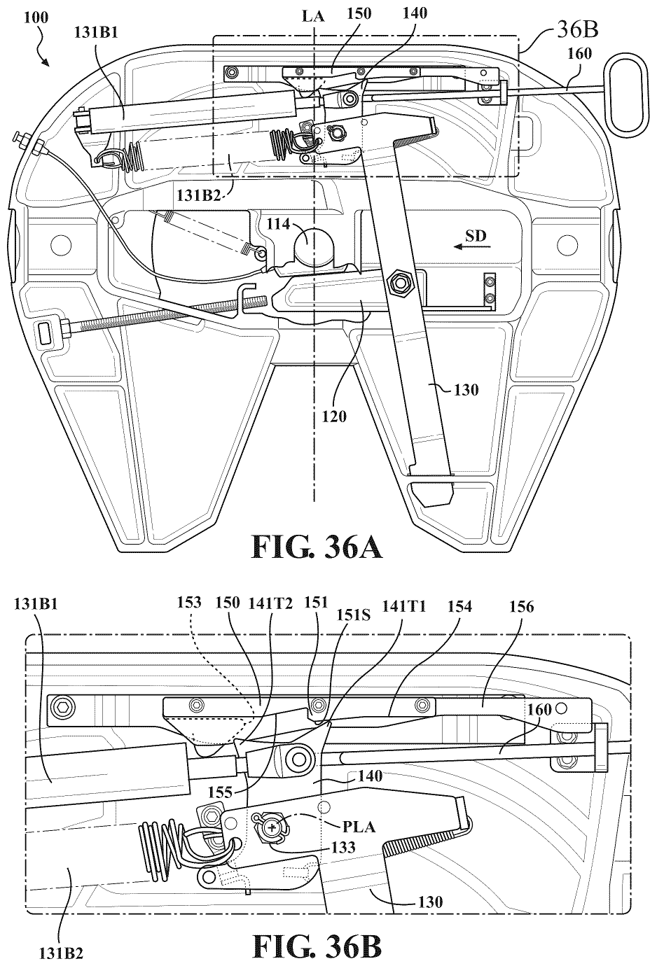

Optionally, to provide a backup to the primary catch mechanism where the pivot lock 140 engages the locking plate 150, for example, where the tooth 141T1 engages or is in close proximity to and cannot move beyond the catch 151, the fifth wheel can include a secondary catch 147. This secondary catch can operate to prevent the pivot lock from rotating when the primary catch fails or malfunctions. As shown in FIG. 19B, the pivot lock 140 defines a pivot lock tail 146. The pivot lock tail 146 extends toward the first biasing member 131B1 and away from the lever 130. The pivot lock tail 146 includes a pivot lock pin 146P, which can be in the form of a pin, bolt, fastener, welded projection or other element extending transversely from the tail 146. The pivot lock pin 146P is configured to engage a secondary catch arm 147A of a secondary catch 147 disposed between the first biasing member 131B1 and the lever 130, or generally near the tail and/or the pivot lock 140. When the pivot lock 140 transitions between the locked and unlocked modes for example, as shown in FIG. 24B, the pivot lock pin 146P moves along a path PLP passing generally around or past the arm 147A, thereby clearing the arm for movement during an unlocking operation. Likewise, when the pivot lock is being returned to a locked mode as shown in FIG. 36B, the pin 147P passes back along a path PLR which is the opposite of path PLP in FIG. 24B to clear the arm 147A.

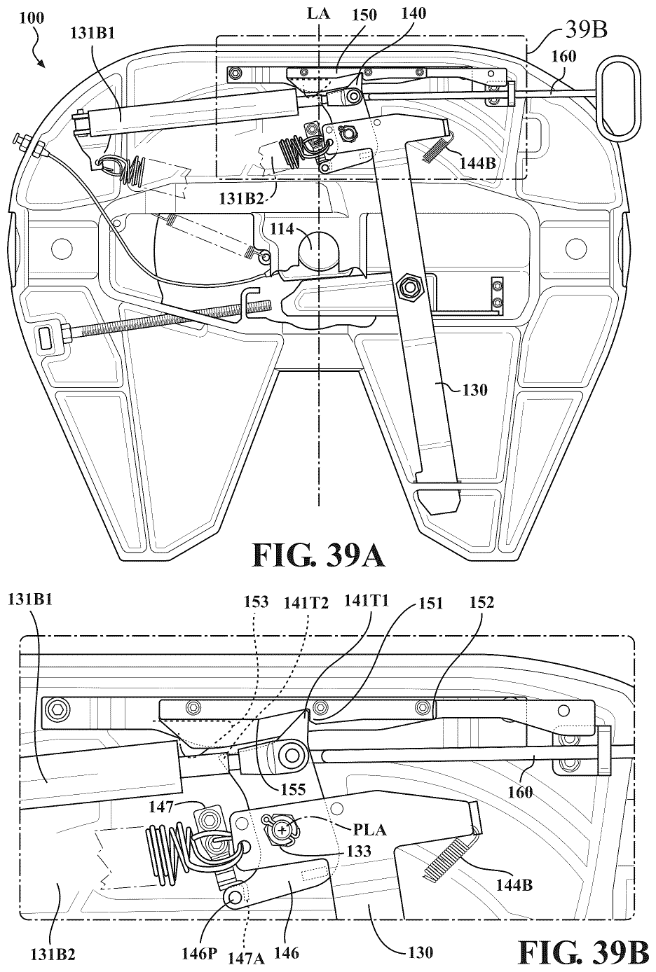

Generally, as shown in FIG. 39B if the spring 131B2 fails, the pin 146P will engage the arm 147A to prevent movement of the pivot lock. As shown there, contact between the secondary catch arm 147A and the pivot lock pin 146P of the pivot lock 140 prevents clockwise rotation of the pivot lock 140. Contact between the secondary catch arm 147A and the pivot lock 140 occurs if a pivot lock biasing member no longer functions to engage the pivot lock first tooth with the first catch, for example, when the pivot lock biasing member 144B is broken into parts (such as a broken coil spring), damaged or disengaged from the pivot lock. As will be appreciated, the catch arm 147A and pin 146P can be reversed and disposed on the opposite elements, that is, the arm on the pivot lock and the pin on the fifth wheel base, or oriented and constructed in different ways.

With further reference to FIGS. 19A-40B, the fifth wheel 100 can include a latch plate 150 disposed in proximity to the pivot lock 140. The latch plate 150 can include a first catch 151 and a reset catch 152 distal from the first catch 151. The latch plate 150 optionally can include a leaf spring 153. The latch plate 150 can define a ramp 154 disposed between the first catch 151 and the reset catch 152. The latch plate 150 can define a recess 155 disposed between the leaf spring 153 and the first catch 151. As used herein, the term “catch” is understood to mean a structural feature designed to engage, retain, restrict, or interface with one or more teeth. The catch may function as a stop, locking mechanism, guide, or engagement point to control movement, positioning, or interaction between components. The term “catch” may include, but is not limited to, recesses, notches, protrusions, latches, or any form of mechanical engagement structure that operates in conjunction with teeth.

The latch plate 150 can include a latch keeper 156. The latch keeper 156 is coupled with the latch plate 150. The latch keeper 156 includes a keeper pin 157 disposed distal from the first catch 151 and opposite the leaf spring 153.

The pivot lock 140 and/or the latch plate 150 can be flat or substantially flat. The term “substantially flat” is understood to describe a surface or structure that is primarily planar but may include minor deviations, curvatures, or irregularities that do not significantly affect its intended function. The term allows for slight bends, contours, or non-uniformities. However, the pivot lock 140 and/or the latch plate 150 are not limited to flat or planar configurations, nor to constructions that are plate-like or flat. For example, the pivot lock 140 and/or the latch plate 150 can be curved, contoured, multi-surfaced, or irregularly shaped forms, provided the pivot lock 140 includes one or more teeth 141T2, 141T2 configured to engage with one or more the catches 151, 152, the leaf spring 153, and various ramps, for example, ramp 154 of the latch plate 150. In some cases, the latch plate can be fastened, secured, welded or otherwise secured to the top plate 111. The latch plate optionally can be removable and replaceable relative thereto so that the part can be replaced and/or services after wear and tear or damage thereto. Likewise, the pivot lock can be removable and replaceable relative to the lever and other components in the fifth wheel.

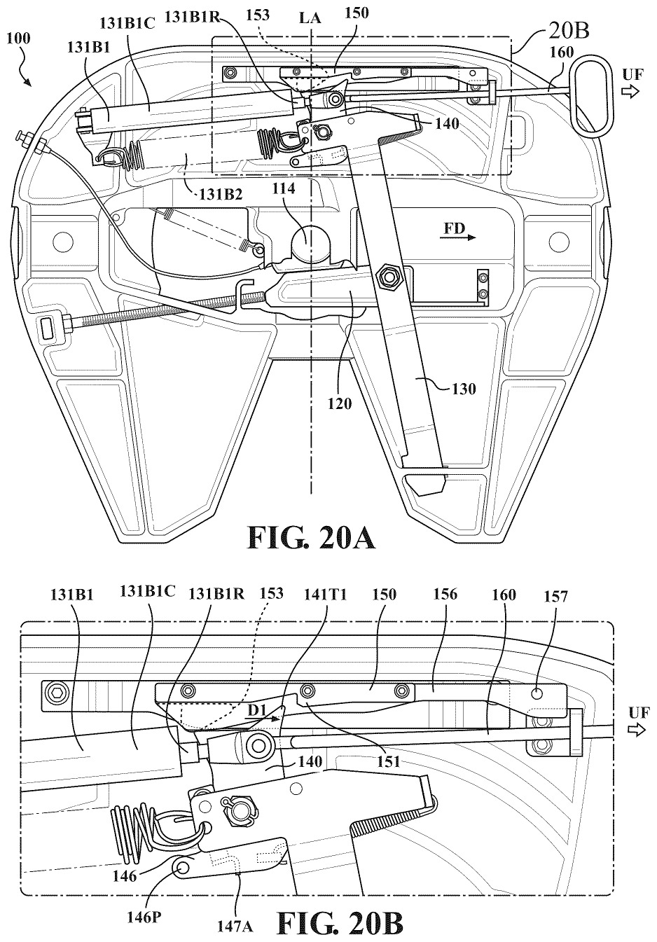

Optionally, the leaf spring 153 as shown in FIG. 19B can resiliently bias against the tooth 141T2 of the lock plate 140. This in turn urges the pivot lock 140 about the pivot lock pivot 133 such that the other tooth 141T1 is urged toward and in most cases against the surface 155 of the lock plate 150. This in turn allows the tooth 141T1 to stay engaged with the lock plate, and maintains the tooth 141T1 in a locked condition so that it cannot pass by the catch 151 on the lock plate. The leaf spring can include a type of ramped spring as shown, which is angled relative to the latch plate, or it can be in another form. The latch spring can include a ramp 153R at the angle A5 relative to the base 153B. That base 153B can be fastened with a fastener to the latch plate or a bracket holding the latch plate distal from the catch 151 but located so as to position the ramp 153R to engage the tooth 141T2 on the pivot lock and urge the other tooth 141T1 into the area near the lock plate so it cannot pass the catch 151 in the locked more. The ramp 153R can transition to an extension 153E, which optionally can project back toward the base. In some cases, the extension can be minimal or absent altogether. The extension and ramp can be moveable or bendable toward the base in direction D12 when the pivot lock 140 is intentionally actuated via input through the handle 160 or first biasing member 131B1 to convert the system from locked to unlocked mode. This is shown in FIG. 20A where the extension 153E and/or the ramp is nearer the base 153B due to the user force UF through the bar to the pivot lock 140 moving or bending those elements toward the base. The pivot lock 140 can be moveable and reconfigurable in a variety of modes and can move on different paths depending on the operation of the fifth wheel. For example, the pivot lock can move, rotate and/or toggle from a locked mode to an unlocked mode and vice versa. As shown in FIGS. 19A, 19B, in the locked mode the pivot lock can be positioned so that the pivot lock first tooth 141T1 is aligned to engage the first catch 151. Specifically, the pivot lock 140 is operable in the locked mode such that the pivot lock first tooth 141T1 will engage or is engaged with the first catch 151, thereby preventing rotation of the lever 130 and thus securing the lock element 120 in the closed position shown in FIG. 19A. Optionally, the leaf spring 153 of the latch plate 150 is configured to engage the pivot lock second tooth 141T2 when the lock element 120 is in the closed position so that the pivot lock 140 cannot transition from the locked mode to the unlocked mode. For example, the second tooth 141T2 can engage the leaf spring 153 to prevent further rotation of the pivot lock 140 to prevent the first tooth 141T1 from clearing the first catch 151 thereby allowing or facilitating an unlocking condition of the system as described below when a spring fails.

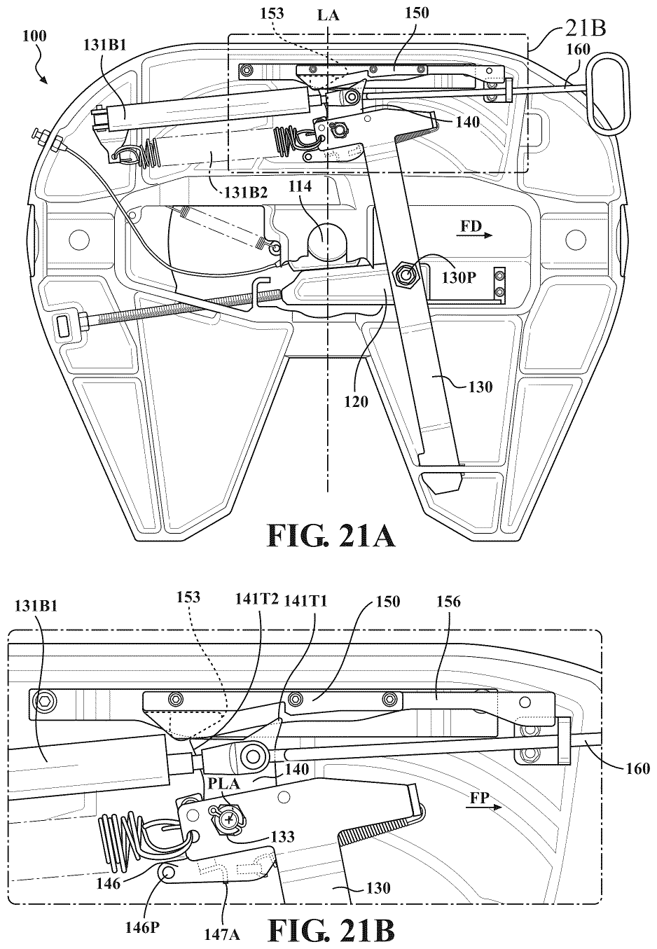

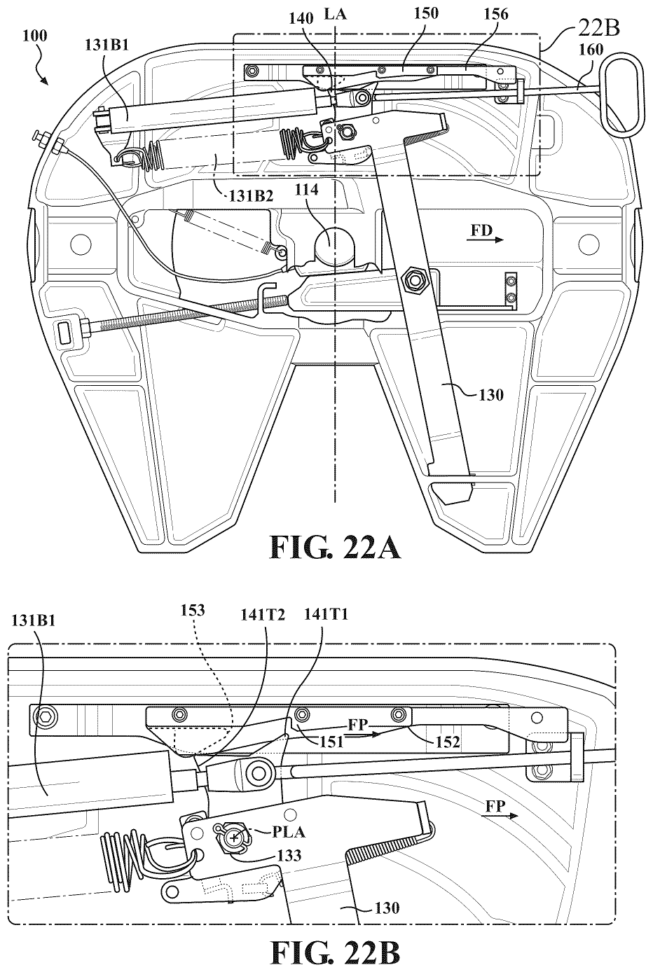

As shown in FIGS. 20A-27B, the first biasing member 131B1 of the lever 130 is configured to urge the pivot lock first tooth 141T1 adjacent the latch plate 150 along a first path FP past the first catch 151 toward and/or past the reset catch 152. The first biasing member 131B1 can be an air cylinder and can be put in an activation mode to extend. As shown in FIG. 20B, the actuator element 160 can be actuated manually by a user via a user force UF, which pulled the pivot lock 140 in direction D1. The second biasing member 131B2 can exert a counterforce and the pivot lock can rotate to initially disengage the pivot lock 140 and the pivot lock first tooth 141T1 from the first catch 151 of the latch plate 150. The first biasing member 131B1 can rotate the pivot lock first tooth 141T1 clockwise, allowing for movement along the first path FP. As shown in FIGS. 21B and 22B, the first biasing member 131B1 continues to hold the pivot lock first tooth 141T1 in a clearance mode such that the pivot lock first tooth 141T1 is able to clear the first catch 151 as the pivot lock first tooth 141T1 moves along the first path FP toward the reset catch 152 under a force of the first biasing member 131B1. As the first biasing member 131B1 moves the pivot lock 140 along the first path FP the lever 130 is likewise rotated clockwise about the locking bar pivot 130P by the force acting on the pivot lock pivot 133 such that the lock element 120 is moved from the closed position toward the open position.

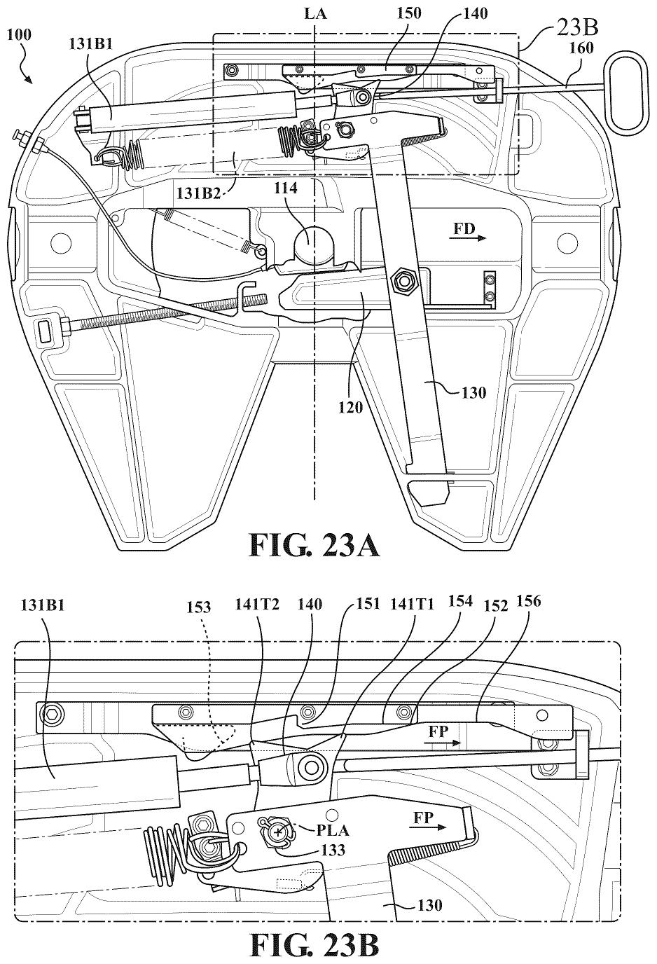

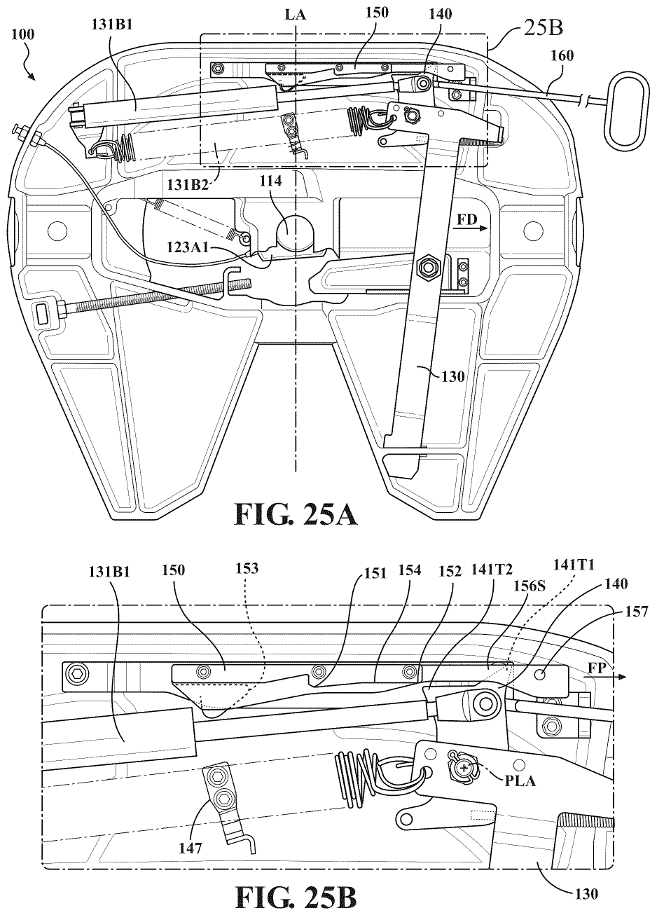

As shown in FIGS. 23A-24B, the first biasing member 131B1 can continue to move the pivot lock first tooth 141T1 and the pivot lock 140 along the first path FP toward the reset catch 152 under the force of the first biasing member 131B1 and/or a force exerted on the actuator element 160. The pivot lock 140 can pivot clockwise about the pivot lock pivot 133 such that the pivot lock second tooth 141T2 engages the ramp 154. The pivot lock pin 146P is displaced past the secondary catch 147 as the pivot lock 140 travels along the first path FP. With reference to FIG. 25B, the first biasing member 131B1 continues to move the pivot lock 140 along the first path FP such that pivot lock second tooth 141T2 moves along the ramp 154 until the pivot lock second tooth 141T2 engages the reset catch 152. The pivot lock first tooth 141T1 moves over the reset catch 152 of the latch plate 150 as the pivot lock 140 moves adjacent the latch plate 150. During the movement of the first tooth along the first path, the first tooth optionally moves along or adjacent the latch plate, away from the longitudinal axis LA of the fifth wheel 100. As the tooth moves along the path FP, it further optionally can rotate about the pivot lock axis PLA as described further below.

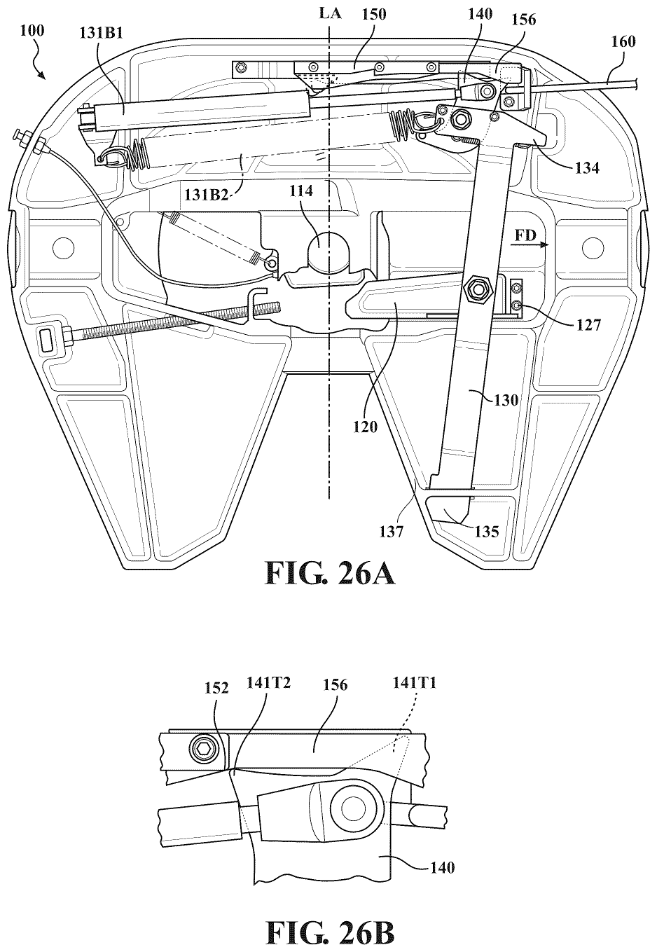

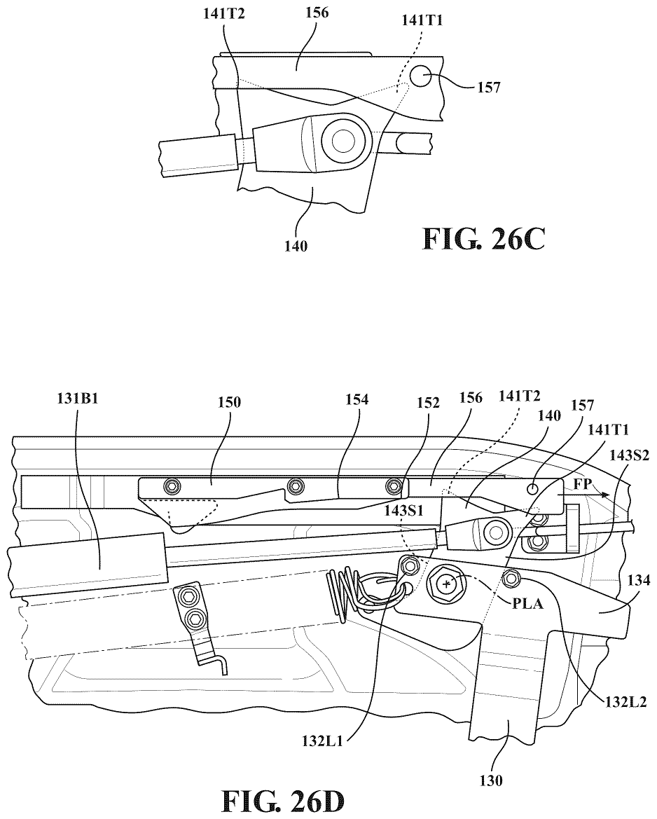

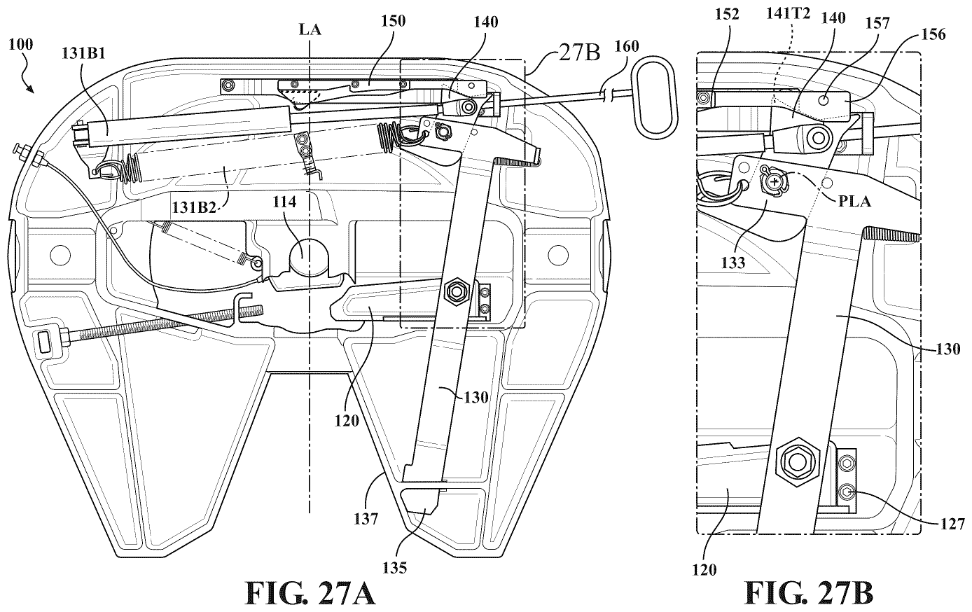

Referring further to FIGS. 25A and 25B, in continuing to convert the lock element from the closed position to the open position to release the king pin, as the first biasing member 131B1 and/or a force exerted on the actuator element 160 moves the pivot lock 140 farther along the first path FP, the pivot lock second tooth 141T2 clears the reset catch 152 of the latch plate 150. As shown in FIGS. 26A-26D, the pivot lock 140 then rotates clockwise. As a result of this rotation, the first tooth moves and rotates away from the longitudinal axis LA and toward and past the keeper pin 157 without contacting the keeper pin 157 (see FIG. 26C) until the second stop 143S2 of the pivot lock 140 engages the second limiter 132L2 of the lever 130, ceasing the clockwise rotation of the pivot lock 140 about the pivot lock axis PLA of the pivot lock pivot 133. The pivot lock 140, as well as the tooth 141T1 however, can continue to move along the first path FP until the lock element 120 contacts a stop block 127 and the lever stop 135 contacts a lever stop wall 137 defined by the fifth wheel 100 or top plate 111, thereby stopping the clockwise rotation of the lever 130. The pivot lock 140 at the end of the first path FP is shown in FIG. 27B, where the second tooth 141T2 and pivot lock 140 have well cleared the reset catch 152 of the latch plate 150.

As depicted in FIGS. 28A and 28B, the lever 130 is rotated counterclockwise and the first biasing member 131B1 and/or a force exerted on the actuator element 160 ceases urging the lever 130 along the first path FP, optionally when the first biasing member enters an inactive mode. In this inactive mode, the first biasing member may be operated such that it no longer exerts a force against the lever. This may be achieved if the first biasing member is an air or pneumatic cylinder, and it is no longer pressurized. In the inactive mode of the first biasing member, the second biasing member 131B2 can take over movement forces exerted on the lever, and can urge the lever 130 along a second path SP.

This second path SP optionally can be generally opposite the first path FP and can be directed back toward the longitudinal axis LA of the fifth wheel. The second end 130E2 of the lever 130 can be pivotally joined with the second biasing member 131B2 configured to urge the pivot lock first tooth 141T1 along the second path SP. The second biasing member 131B2 continues urging the pivot lock second tooth 141T2 to engage the reset catch 152 on its stopping surface 152S to hold the lever 130 in a fixed position, without further rotation under force of the springs 131B2 and maintain the lock element 140 in the open position as shown in FIGS. 28A and 28B. In the knock off position of the lock element shown in FIGS. 29A and 29B, the lock jaw biasing member 126 urges rotation of the lock jaw 123 about the lock jaw pivot 123PV such that the arms 123A1 and 123A2 are open to the throat, so that the kingpin 114 may be released from the throat 112 of the fifth wheel 100.

With reference to FIG. 28B, the pivot lock 140 is operable in the unlocked mode in which the pivot lock second tooth 141T2 engages the reset catch 152 and the surface 152S to hold the lever 130 in a position and maintain the lock element 120 in the open position. The second stop 143S2 engages the second limiter 132L2 of the lever 130 when the pivot lock second tooth 141T2 engages the reset catch 152.

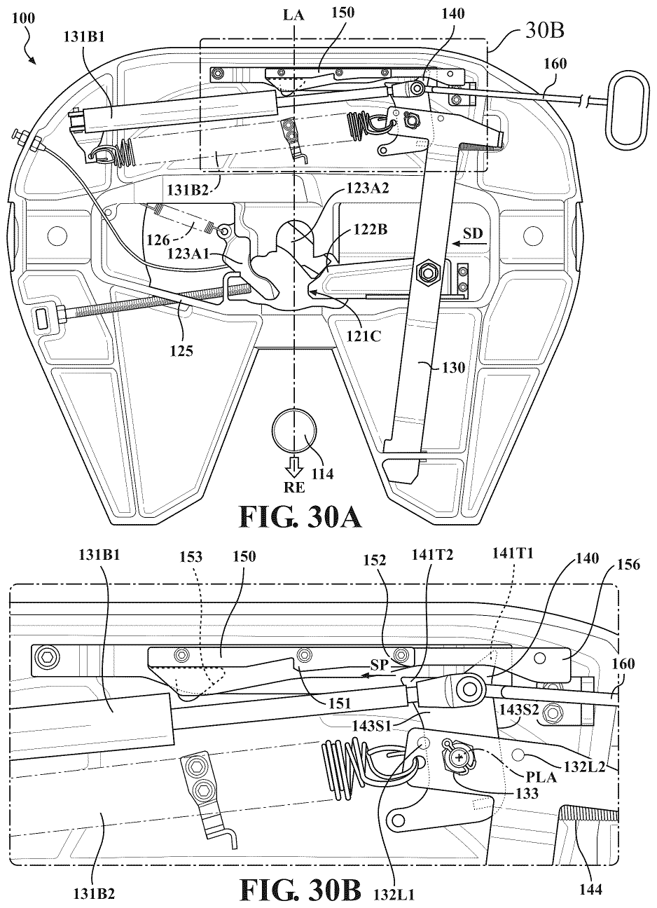

With reference to FIGS. 29A and 30A, the lock jaw 123 pivots about the lock jaw pivot 123PV, transitioning into the open position where the first locking arm 123A1 contacts the casting rib 111A such that the removal of the kingpin 114 between the first locking arm 123A1 and the rounded portion 122R of the contact surface 121C from the throat 112 is permitted. The kingpin 114 contacts the rounded portion 122R of the contact surface 121C of the lock element 120, engaging the lock element 120 against the lever 130 such that the pivot lock second tooth 141T2 is disengaged from the reset catch 152 of the latch plate 150 as shown in FIGS. 29B and 30B. The pivot lock biasing member 144 urges the first stop 143S1 to engage the first limiter 132L1 of the lever 130 to urge the pivot lock 140 into a reset catch clearance mode (e.g., a “ready to couple” condition). In the reset catch clearance mode the pivot lock second tooth 141T2 clears the reset catch 152, allowing the pivot lock second tooth 141T2 to travel toward the first catch 151 along the latch plate 150 along the second path SP with the first tooth.

As depicted in FIGS. 30A and 30B, the second biasing member 131B2 urges the pivot lock 140 along the second path SP such that the pivot lock second tooth 141T2 clears the reset catch 152 with the pivot lock 140 rotating counterclockwise about the pivot lock axis PLA relative to the lever 130. The kingpin 114 can continue in direction RE and can fully exited the throat 112 of the fifth wheel 100.

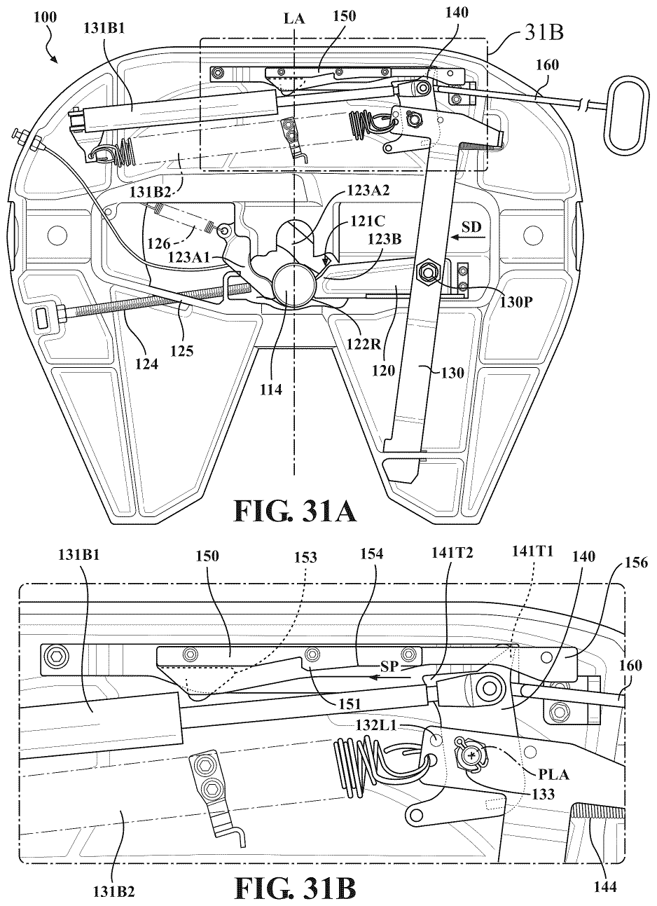

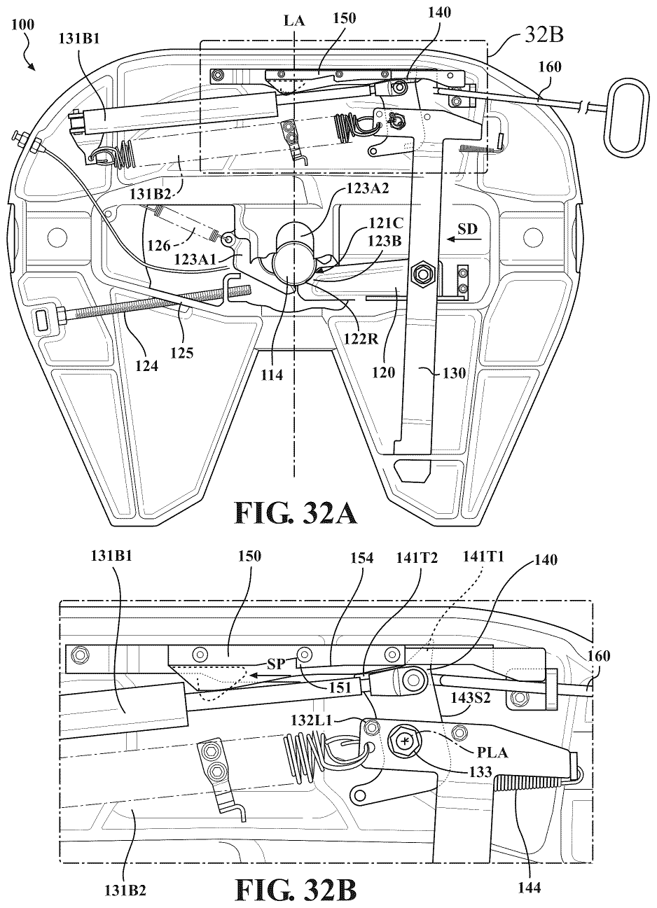

After removal of the kingpin from the fifth wheel, the lock element 120 is held in the open mode by the lock jaw arm 123A2, that kingpin or another kingpin of another trailer can be hooked to the fifth wheel to join a trailer to the vehicle to which the fifth wheel is attached. For example, as shown in FIGS. 31A-32B, the kingpin 114 (which may be the same or different kingpin as the kingpin that was removed) can enter the lock jaw 123, pass the lock element 120 and contact the rounded portion 122R of the contact surface 121C of the lock element 120. This can engage the lock element 120 against the lever 130. The entry of the kingpin 114 can move the lever 130 such that is rotates clockwise about the locking bar pivot 130P. The pivot lock 140 can rotate such that the first stop 143S1 engages the first limiter 132L1. In this condition, the pivot lock 140 can be configured to move along the second path SP and clear the reset catch.

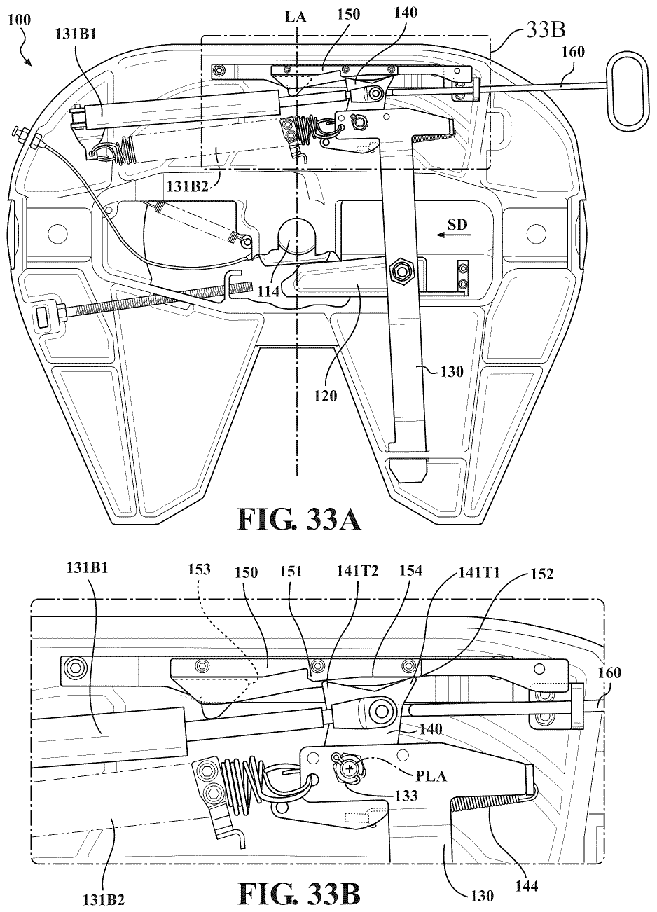

With reference to FIGS. 33A and 33B, the second biasing member 131B2 can urge the pivot lock 140 along the second path SP. The lock element 120 can move from the unlocked position toward the locked position as the pivot lock 140 moves along the second path SP. The pivot lock second tooth 141T2 can engage and slide along the ramp 154 to clear the first catch 151. The pivot lock biasing member 144 can urge the pivot lock 140 to move along the latch plate 150 as the second biasing member 131B2 moves the lever 130 to transition the lock element 120 from the open position to the closed position.

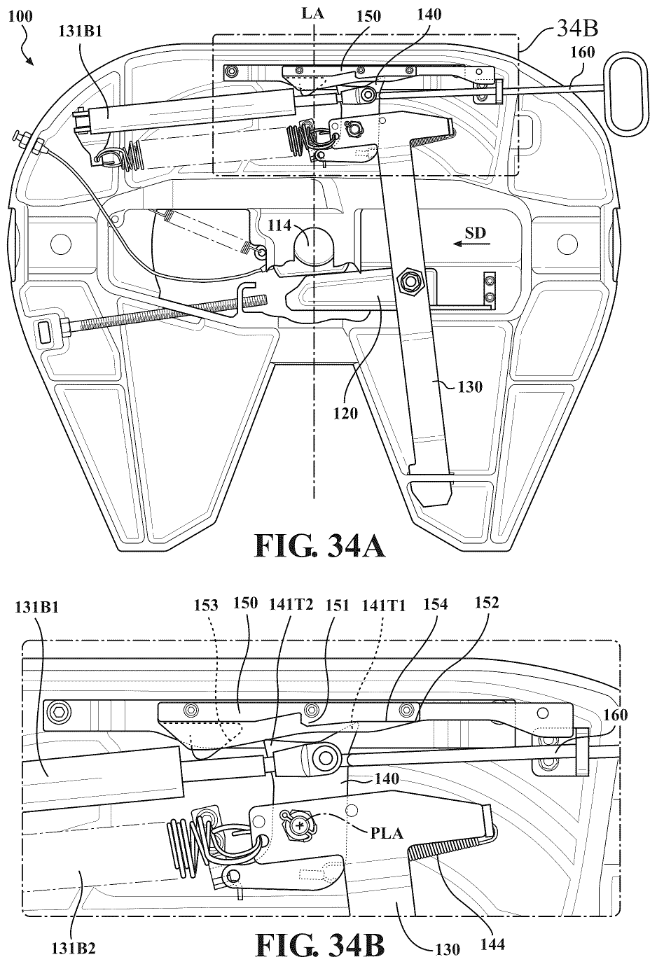

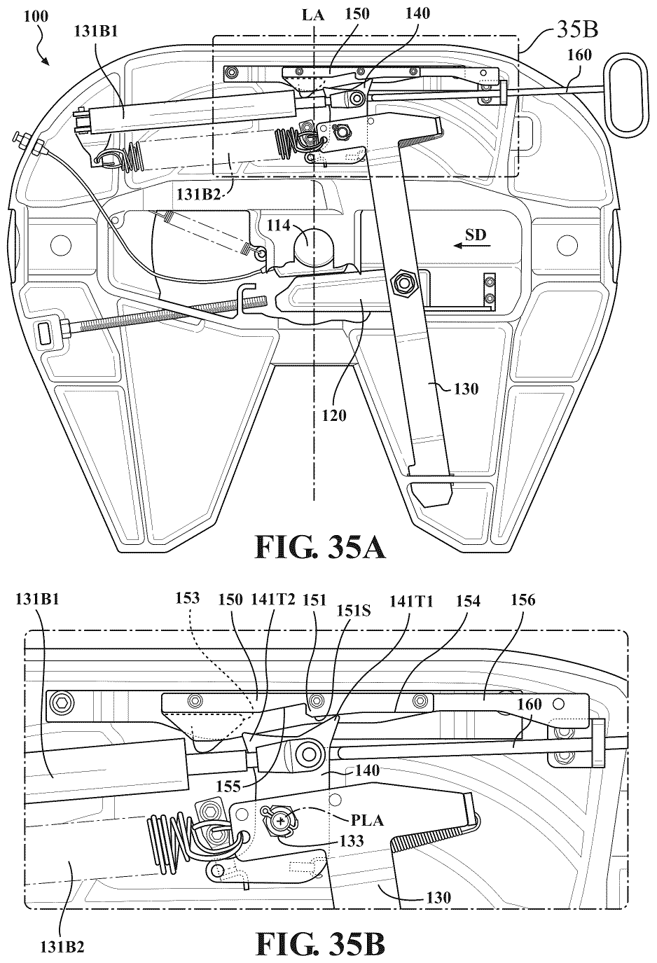

FIGS. 34A and 34B depict the pivot lock 140 continuing to travel along the second path SP toward a longitudinal axis LA of the fifth wheel 100 with the pivot lock second tooth 141T2 clearing the first catch 151. The pivot lock 140 rotates counterclockwise about the pivot lock axis PLA under a force exerted by the pivot lock biasing member 144. The pivot lock first tooth 141T1 engages and slides along the ramp 154. In FIGS. 35A-36B, the pivot lock 140 continues to travel along the second path SP toward a longitudinal axis LA of the fifth wheel 100. The pivot lock 140 rotates counterclockwise about the pivot lock axis PLA such that the pivot lock first tooth 141T1 engages and slides up the ramp 151S on the rear surface of the first catch 151 such that the first tooth clears the first catch 151. The pivot lock pin 146P is displaced past the secondary catch 147 as the pivot lock 140 travels along the second path SP.

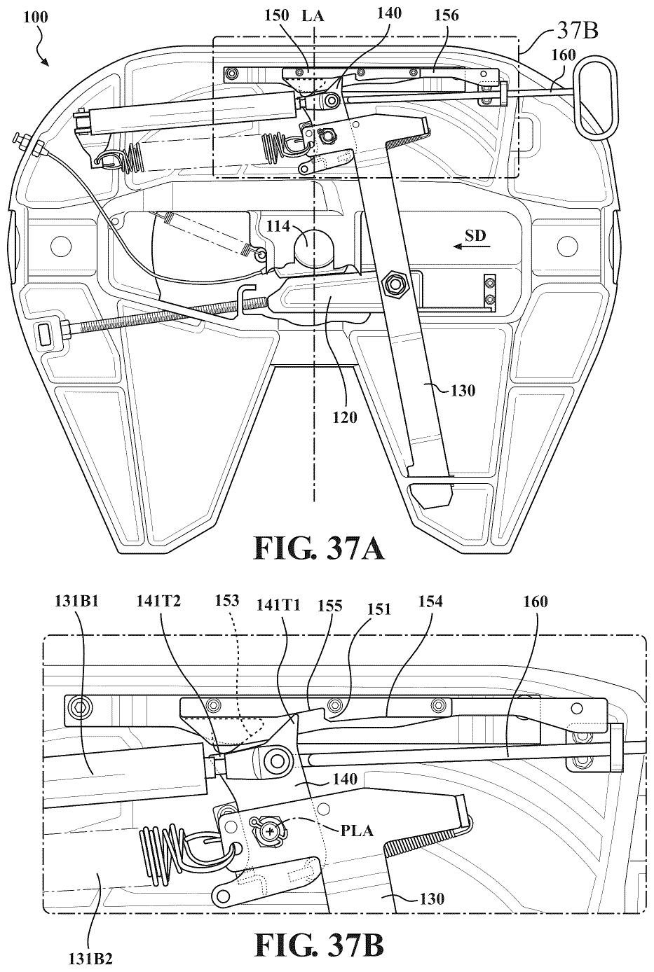

With reference to FIGS. 37A-37B, the pivot lock 140 ceases its movement along the second path SP under the force of the second biasing member 131B2 when the rounded portion 122R of the contact surface 121C of the lock element 120 contacts the adjustment bar 124. The pivot lock first tooth 141T1 is disposed adjacent the latch plate 150 and is located in the recess 155, between the first catch 151 and the leaf spring 153. The pivot lock first tooth 141T1 is prevented from moving along the first path FP beyond the first catch 151, away from the longitudinal axis, while the leaf spring 153 contacts the latch plate 140 proximate the pivot lock second tooth 141T2. This disposition prevents the movement of the lock bar and/or lock jaw from the closed position to the open position, thereby retaining the kingpin 114.

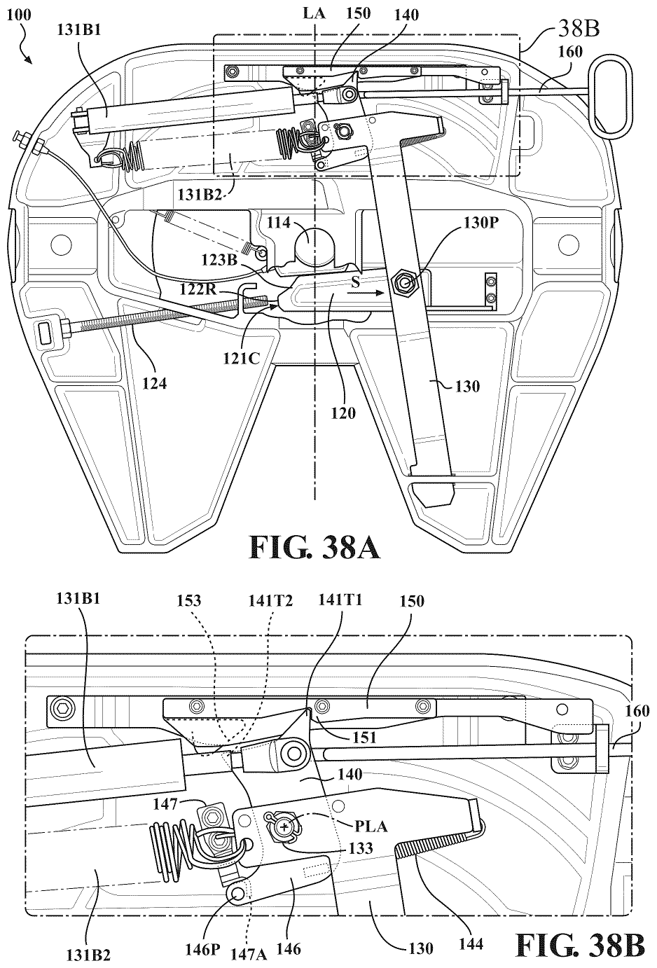

The fifth wheel 100 herein also can provide extra safety features to prevent the pivot lock from inadvertently unlocking during a condition of squirting, for example, when the lock element is under tremendous force by the kingpin such that it is urged to move slightly out of the throat, thereby rotating the lever and the associated pivot lock. With reference to FIGS. 38A and 38B, the lock element 120 squirts in direction S such that the rounded portion 122R of the contact surface 121C of the lock element 120 no longer contacts the adjustment bar 124 and rotates the lever 130 clockwise about the locking bar pivot 130P. The pivot lock first tooth 141T1, however, will automatically engage the first catch 151 due to the spring 144, while the leaf spring 153 contacts the pivot lock second tooth 141T2, such that the pivot lock 140 cannot move farther along the first path FP beyond the first catch. Accordingly, the lock element cannot move from the closed position to the open position and allow the kingpin 114 to be inadvertently released.

The fifth wheel 100 herein can provide extra safety features to prevent the pivot lock from inadvertently unlocking if a pivot lock biasing member no longer functions to engage the pivot lock first tooth with the first catch, for example, when the pivot lock biasing member is broken into parts (such as a broken coil spring), damaged or disengaged from the pivot lock. For example, FIGS. 39A and 39B show a pivot lock biasing member 144B and second biasing member 131B2 that have broken into parts, in which case it no longer exerts a force on the pivot lock to engage the catch 151. In this broken condition of the biasing elements, the secondary catch arm 147A of the secondary catch retainably engages the pivot lock pin 146P. This engagement of the pivot lock secondary catch arm 147A with the pivot lock pin 146P prevents counterclockwise rotation of the pivot lock 140, thereby preventing the pivot lock first tooth 141T1 from clearing the first catch 151 and moving along the first path FP toward the reset catch 152. The engagement of the pivot lock secondary catch arm 147A with the pivot lock pin 146P therefore prevents the lock element 120 from moving from the open position to the closed position. It will be appreciated that the configuration of and engagement between the pivot lock 140 and the latch plate 150 is effective in securely retaining the kingpin 114 within the throat 112 of the fifth wheel 100, even in circumstances where the lock element 120 squirts or the pivot lock biasing member 144 fails.

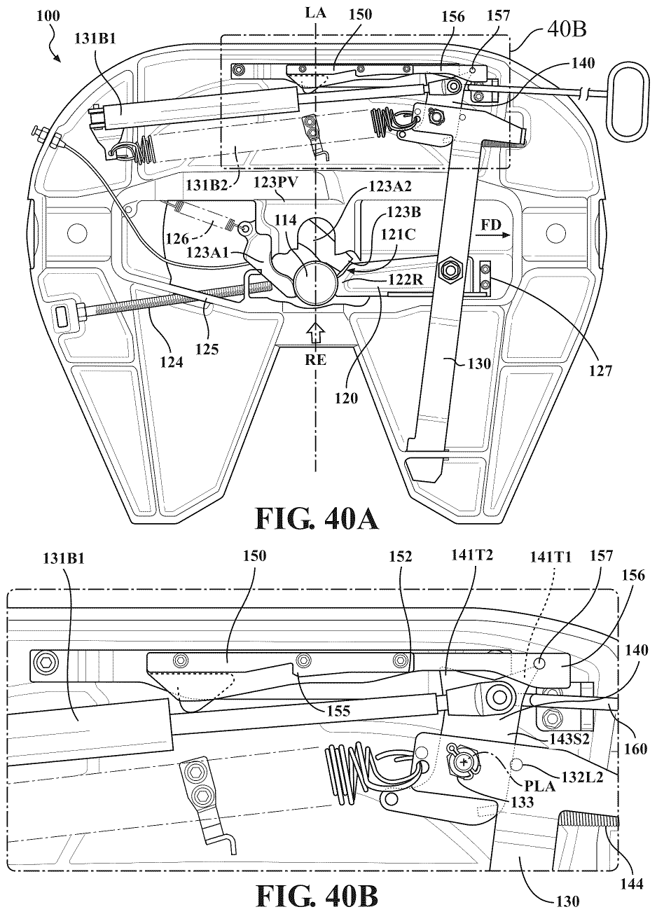

In circumstances where the kingpin 114 enters the throat 112 at a high rate of speed, the excess force of the kingpin 114 entering the throat 112 can force the lock element 120 in the first direction FD toward the stop block 127. This displacement of the lock element 120 pivots the lever 130 clockwise, rotating the pivot lock 140. The keeper pin 157 contacts the pivot lock first tooth 141T1 as shown in FIGS. 40A and 40B. The contact between the keeper pin 157 and the pivot lock first tooth 141T1 prevents the pivot lock 140 from further clockwise rotation, and prevents accidental transition into the unlocked mode.

As mentioned above, the fifth wheel 100 can include an actuator element 160 joined with the pivot lock 140 and configured to move the pivot lock 140. As shown in FIG. 19A, the actuator element 160 can be rotatably joined with the pivot lock 140 at the actuator pivot 142P. The actuator element 160 can include a first end 161 and a second end 162. The first end 161 can include a handle 163 disposed outside of the fifth wheel 100 and graspable by a user to move the pivot lock 140. The second end 162 can be rotatably joined with the pivot lock 140 at the actuator pivot 142P. The actuator element 160 terminates adjacent the actuator pivot 142P. The actuator element 160 and the first biasing member 131B1 can both be rotatably joined with the pivot lock 140 via an actuator pivot 142P extending through the pivot lock 140. The actuator element 160 can be at least partially disposed within an actuator element retainer bracket and guide 164 disposed within the fifth wheel 100.

The following Statements define the above and other embodiments described herein.

Statement A. A fifth wheel comprising: a top plate defining a throat configured to receive a kingpin of a trailer; a lock element moveable between a closed position where the lock element blocks removal of the kingpin from the throat and an open position permitting removal of the kingpin from the throat; a lever operatively connected with the lock element; a pivot lock operatively connected with the lever at a pivot lock pivot, the pivot lock including a pivot lock first tooth and a pivot lock second tooth distal from the pivot lock pivot; and a latch plate disposed in proximity to the pivot lock, the latch plate including a first catch and a reset catch distal from the first catch, wherein the pivot lock is operable in a locked mode in which the pivot lock first tooth engages the first catch thereby preventing rotation of the lever and thus securing the lock element in the closed position, wherein the pivot lock is operable in an unlocked mode in which the pivot lock second tooth engages the reset catch to hold the lever in a position and thus maintain the lock element in the open position, whereby the kingpin is removable from the throat to decouple the trailer from the fifth wheel when the lock element is in the open position.

Statement B. The fifth wheel of Statement A, comprising a secondary catch configured to prevent rotation of the pivot lock in the event of failure or malfunction of the latch plate.

Statement C. The fifth wheel of any preceding Statement, wherein the pivot lock defines a pivot lock tail extending away from the lever, the pivot lock tail including a pivot lock pin configured to interact with the secondary catch.

Statement D. The fifth wheel of any preceding Statement, wherein the secondary catch includes a secondary catch arm positioned to be engaged by the pivot lock pin during inadvertent movement of the pivot lock between the locked mode and the unlocked mode.

Statement E. The fifth wheel of any preceding Statement, wherein the secondary catch is configured to allow passage of the pivot lock pin along a defined path beyond or around the secondary catch arm as the pivot lock transitions between the locked mode and the unlocked mode.

Statement F. The fifth wheel of any preceding Statement, wherein the secondary catch is aligned to permit the pivot lock pin to move past the secondary catch arm without interference during normal operation.

Statement G. The fifth wheel of any preceding Statement, wherein the secondary catch arm is positioned to block movement of the pivot lock tail and thus the pivot lock upon failure of the latch plate to prevent unintended movement of the pivot lock to an unlocked mode.

Statement H. The fifth wheel of any preceding Statement, wherein the pivot lock pin comprises a transversely extending projection that is at least one of a pin, a bolt, a fastener, and a welded element.

Statement I. The fifth wheel of any preceding Statement, wherein the pivot lock pin follows a first path past the secondary catch when transitioning from the locked mode to the unlocked mode, and a reverse path when returning to the locked mode.

Statement J. The fifth wheel of any preceding Statement, wherein the secondary catch arm is resiliently biased toward a position to engage the pivot lock pin upon failure of the primary catch engagement between the pivot lock and the latch plate.

Statement K. The fifth wheel of any preceding Statement, comprising a leaf spring configured to resiliently bias the pivot lock toward a locked position.

Statement L. The fifth wheel of any preceding Statement, wherein the leaf spring engages a tooth of the pivot lock to urge another tooth of the pivot lock toward and into engagement with a catch on the latch plate.

Statement M. The fifth wheel of any preceding Statement, wherein the leaf spring includes a base secured to the latch plate or to a bracket supporting the latch plate.

Statement N. The fifth wheel of any preceding Statement, wherein the leaf spring includes a ramp angled relative to the base and positioned to engage a tooth of the pivot lock.

Statement O. The fifth wheel of any preceding Statement, wherein the ramp urges the pivot lock to rotate about a pivot such that the tooth of the pivot lock remains engaged with the catch of the latch plate in the locked mode.

Statement P. The fifth wheel of any preceding Statement, wherein the ramp transitions into an extension projecting back toward the base of the leaf spring, or wherein the ramp or extension is configured to deflect toward the base of the leaf spring when force is applied to move the pivot lock from the locked mode to the unlocked mode.

Statement Q. The fifth wheel of any preceding Statement, wherein the ramp of the leaf spring is formed at a predetermined angle relative to the base to optimize biasing force against the pivot lock.

Statement R. The fifth wheel of any preceding Statement, wherein the leaf spring comprises a unitary piece of resilient material formed to define the base, the ramp, and the extension as a single continuous structure.

Although the different elements and assemblies of the embodiments are described herein as having certain functional characteristics, each element and/or its relation to other elements can be depicted or oriented in a variety of different aesthetic configurations, which support the ornamental and aesthetic aspects of the same. Simply because an apparatus, element or assembly of one or more of elements is described herein as having a function does not mean its orientation, layout or configuration is not purely aesthetic and ornamental in nature.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

In addition, when a component, part or layer is referred to as being “joined with,” “on,” “engaged with,” “adhered to,” “secured to,” or “coupled to” another component, part or layer, it may be directly joined with, on, engaged with, adhered to, secured to, or coupled to the other component, part or layer, or any number of intervening components, parts or layers may be present. In contrast, when an element is referred to as being “directly joined with,” “directly on,” “directly engaged with,” “directly adhered to,” “directly secured to,” or “directly coupled to” another element or layer, there may be no intervening elements or layers present. Other words used to describe the relationship between components, layers and parts should be interpreted in a like manner, such as “adjacent” versus “directly adjacent” and similar words. As used herein, the term “and/or” includes any and all combinations of one or more of the associated listed items.

The above description is that of current embodiments of the invention. Various alterations and changes can be made without departing from the broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, any combination of X, Y and Z, for example, X, Y, Z; X, Y; X, Z; Y, Z, and/or any other possible combination together or alone of those elements, noting that the same is open ended and can include other elements.

Reference throughout this specification to “a current embodiment” or “an embodiment” or “alternative embodiment” means that a particular feature, structure, or characteristic described in connection with the embodiment is included in at least one embodiment herein. Accordingly, the appearance of the phrases “in one embodiment” or “in an embodiment” or “in an alternative embodiment” in various places throughout this specification are not necessarily all referring to the same embodiment. Additionally, the features, structures, or characteristics of one embodiment are contemplated for proper and full combination in any suitable manner in one or more other embodiments, which is fully contemplated herein. Further, features, structures, or characteristics of one embodiment or multiple embodiments are readily and completely mixed and matched with any features, structures, or characteristics of any other embodiment or multiple embodiments in varying combinations and permutations.

What is claimed is:

1. A fifth wheel comprising:
a top plate defining a throat configured to receive a kingpin of a trailer;
a lock element movable between a closed position where the lock element blocks removal of the kingpin from the throat and an open position permitting removal of the kingpin from the throat;
a lever including a first end and a second end, the lock element operatively connected with the lever between the first end and the second end;
a pivot lock rotatably joined with the second end of the lever at a pivot lock pivot, the pivot lock including a pivot lock first tooth and a pivot lock second tooth distal from the pivot lock pivot;
an actuator element joined with the pivot lock and configured to move the pivot lock; and
a latch plate disposed in proximity to the pivot lock, the latch plate including a first catch and a reset catch distal from the first catch,
wherein the pivot lock is operable in a locked mode in which the pivot lock first tooth engages the first catch thereby preventing rotation of the lever and thus securing the lock element in the closed position,
wherein the pivot lock is operable in an unlocked mode in which the pivot lock second tooth engages the reset catch to hold the lever in a position and thus maintain the lock element in the open position,
whereby the kingpin is removable from the throat to decouple the trailer from the fifth wheel when the lock element is in the open position.

2. The fifth wheel of claim 1, comprising:
a first biasing member configured to urge the lever in a first direction;
a second biasing member configured to urge the lever in a second direction, opposite the first direction.

3. The fifth wheel of claim 2,
wherein the first biasing member is rotatably joined with the pivot lock at an actuator pivot,
wherein the actuator element is rotatably joined with the pivot lock at the actuator pivot,
wherein the second biasing member is joined with the lever at the second end.

4. The fifth wheel of claim 3,
wherein the first biasing member is an air cylinder,
wherein the air cylinder ceases urging the lever in the first direction in an inactive mode, such that the second biasing member urges the lever in the second direction, thereby urging the pivot lock second tooth to engage the reset catch to hold the lever in a position and thus maintain the lock element in the open position.

5. The fifth wheel of claim 4,
wherein the pivot lock includes a first stop and the lever includes a first limiter,
wherein the first stop engages the first limiter when the pivot lock second tooth engages the reset catch such that the pivot lock is impaired from rotating about the pivot lock axis.

6. The fifth wheel of claim 1, comprising:
a secondary catch; and
wherein the pivot lock defines a pivot lock tail comprising a pivot lock pin configured to engage the secondary catch.

7. The fifth wheel of claim 6,
wherein the secondary catch comprises a secondary catch arm configured to retainably engage the pivot lock pin and prevent rotation of the pivot lock in a direction.

8. The fifth wheel of claim 6,
wherein the secondary catch defines a path through which the pivot lock pin is configured to be displaced as the pivot lock transitions between the locked mode and the unlocked mode.

9. The fifth wheel of claim 1, comprising:
a spring coupled to the latch plate,
wherein the spring includes a ramp angled relative to the base and positioned to engage a second tooth of the pivot lock distal from the first tooth.

10. The fifth wheel of claim 1,
wherein the ramp urges the pivot lock to rotate about a pivot such that the first tooth of the pivot lock remains engaged with the latch plate in the locked mode.

11. A fifth wheel comprising:
a top plate defining a throat configured to receive a kingpin of a trailer;
a lock element moveable between a closed position where the lock element blocks removal of the kingpin from the throat and an open position permitting removal of the kingpin from the throat;
a lever operatively connected with the lock element;
a pivot lock operatively connected with the lever at a pivot lock pivot, the pivot lock including a pivot lock first tooth and a pivot lock second tooth distal from the pivot lock pivot; and
a latch plate disposed in proximity to the pivot lock, the latch plate including a first catch and a reset catch distal from the first catch,
wherein the pivot lock is operable in a locked mode in which the pivot lock first tooth engages the first catch thereby preventing rotation of the lever and thus securing the lock element in the closed position,
wherein the pivot lock is operable in an unlocked mode in which the pivot lock second tooth engages the reset catch to hold the lever in a position and thus maintain the lock element in the open position,
whereby the kingpin is removable from the throat to decouple the trailer from the fifth wheel when the lock element is in the open position.

12. The fifth wheel of claim 11,
wherein the latch plate includes a leaf spring distal from the first catch, with the first catch disposed between the leaf spring and the reset catch,
wherein the pivot lock second tooth is configured to engage the leaf spring to prevent the lock element from transitioning from the open position.

13. The fifth wheel of claim 11, comprising:
a secondary catch configured to prevent rotation of the pivot lock in the event of failure or malfunction of the latch plate,
wherein the pivot lock defines a pivot lock tail,
wherein the pivot lock tail includes a pivot lock pin configured to interact with the secondary catch.

14. The fifth wheel of claim 12,
wherein the secondary catch defines a path configured to allow passage of the pivot lock pin along a defined path beyond or around the secondary catch arm as the pivot lock transitions between the locked mode and the unlocked mode.

15. The fifth wheel of claim 12, wherein the secondary catch includes a secondary catch arm positioned to be engaged by the pivot lock pin during inadvertent movement of the pivot lock between the locked mode and the unlocked mode.

16. The fifth wheel of claim 11, comprising:
a spring coupled to the latch plate,
wherein the spring includes a ramp angled relative to the base and positioned to engage a tooth of the pivot lock.

17. The fifth wheel of claim 16, wherein the ramp urges the pivot lock to rotate about a pivot such that the tooth of the pivot lock remains engaged with the latch plate in the locked mode.

18. A fifth wheel comprising:
a top plate defining a throat configured to receive a kingpin of a trailer;
a lock element movable between a closed position where the lock element impairs removal of the kingpin from the throat and an open position permitting unimpaired removal of the kingpin from the throat;
a lever operatively connected with the lock element;
a pivot lock operatively connected with the lever at a pivot lock pivot, the pivot lock including a pivot lock first tooth and a pivot lock second tooth distal from the pivot lock pivot; and
a latch plate disposed in proximity to the pivot lock, the latch plate including a first catch and a reset catch distal from the first catch, the pivot lock first tooth and pivot lock second tooth distal from the lever and protruding toward the latch plate;
wherein the pivot lock is operable in a locked mode to secure the lock element in the closed position, and in an unlocked mode to maintain the lock element in the open position,
whereby the kingpin is removable from the throat to decouple the trailer from the fifth wheel when the lock element is in the open position.

19. The fifth wheel of claim 18 comprising:
a latch keeper coupled with the latch plate, the latch keeper comprising a keeper pin disposed distal from the first catch.

20. The fifth wheel of claim 19,
wherein the latch keeper defines a latch stop surface configured to contact the pivot lock first tooth.
